(19) United States
(12) Patent Application Publication
(10) Pub. No.: US 2023/0066871 A1
(43) Pub. Date: Mar. 2, 2023

(54) USER-INTERACTIVE TOOLS AND METHODS FOR CONFIGURING BUILDING EQUIPMENT SYSTEMS

(71) Applicant: Johnson Controls Tyco IP Holdings LLP, Milwaukee, WI (US)

(72) Inventors: Steven R. Murray, Cedarburg, WI (US); Claude E. Doyle, JR., Menomonee Falls, WI (US); Bryan A. Register, Brookfield, WI (US); Isaac J. Krull, Glendale, WI (US); Scott A. Blundell, Cloudcroft, NM (US); Nigel Robjohns, Wauwatosa, WI (US); Robert L. Graves, Jamestown, CO (US); Gary G. Schmidt, JR., Waukesha, WI (US)

(73) Assignee: Johnson Controls Tyco IP Holdings LLP, Milwaukee, WI (US)

(21) Appl. No.: 17/464,557

(22) Filed: Sep. 1, 2021

(51) Int. Cl. G06Q 10/06; G06Q 50/08; G05B 13/02; G06F 3/0484; G06F 3/0482

(52) U.S. Cl. CPC G06Q 10/06313; G06Q 50/08; G05B 13/0265; G06F 3/04847; G06F 3/0482; G06F 3/0483

(57) ABSTRACT

A user-interactive tool for configuring a building equipment system includes one or more processors and one or more memory devices having instructions stored thereon that, when executed by the one or more processors, cause the one or more processors to perform operations including receiving a first user input including project information, obtaining equipment configuration data for a plurality of building equipment components capable of being included in the building equipment system based on the project information, receiving a second user input defining a configuration of the building equipment system, generating a predicted metric of the building equipment system based on the project information and the configuration of the building equipment system, displaying the predicted metric and a representative metric of a set of historical building equipment installation projects via a graphical user interface, and adjusting the predicted metric of the building equipment system based on the representative metric.

### BACKGROUND

The present disclosure relates generally to systems and methods for configuring building equipment systems. The present disclosure relates more particularly to tools for configuring and planning building equipment system installation projects.

Maintaining occupant comfort in a building requires building equipment, such as heating, ventilating, or cooling (HVAC) equipment, to be installed and operated to change environmental conditions in the building. HVAC equipment is often customized to the building the HVAC equipment is applied. Typically, these customizations are quoted and priced based on a quoting party's (e.g., dealer's) experience of designing and quoting HVAC equipment. Often, HVAC equipment quotes are inaccurate and fail to consider large-scale factors and the numerous application specific customizations available to a customer or purchaser of HVAC equipment. Inaccurate quotes can lead to loss in profits and/or customer annoyance. This is particularly relevant in context of large-scale factors where a dealer may not have experience with quoting projects in context of large-scale factors (e.g., various geographical locations, various vertical markets, etc.).

### SUMMARY

One implementation of the present disclosure is a user interactive tool for configuring a building equipment system including one or more processors, and one or more memory devices. In some embodiments, the one or more memory devices have instructions stored thereon that, when executed by the one or more processors, cause the one or more processors to perform operations. In some embodiments, the operations include receiving a first user input including project information including an attribute of a prospective building equipment installation project. In some embodiments, the operations include obtaining equipment configuration data for a plurality of building equipment components capable of being included in the building equipment system based on the project information. In some embodiments, the operations include receiving a second user input including a selected subset of the plurality of building equipment components, the selected subset defining a configuration of the building equipment system. In some embodiments, the operations include generating a predicted metric of the building equipment system based on the project information and the configuration of the building equipment system. In some embodiments, the operations include generating a representative metric of a set of historical building equipment installation projects that satisfy the attribute of the prospective building equipment installation project. In some embodiments, the operations include displaying, via graphical user interface, the predicted metric of the building equipment system and the representative metric of the set of historical building equipment installation projects. In some embodiments, the operations include adjusting the configuration of the building equipment system based on the representative metric.

In some embodiments, the operations include communicating the project information to a machine learning system configured to use the project information and one or more patterns identified in the set of historical building equipment installation projects to determine at least one of the plurality of building equipment components capable of being used in the building equipment system.

In some embodiments, the project information comprises at least one of vertical market information, project complexity information, locale information, start date information, and end date information.

In some embodiments, the operations further include receiving a third user input including equipment preferences including at least one of a controller preference, a variable frequency drive preference, an air handling unit preference, a damper preference, or an air flow monitoring station preference. In some embodiments, the equipment configuration data are obtained based on both the project information and the equipment preferences.

In some embodiments, adjusting the configuration of the building equipment system includes automatically changing the selected subset of the plurality of building equipment components to decrease a difference between the predicted metric and the representative metric.

In some embodiments, the operations include filtering the set of historical building equipment installation projects to generate a filtered subset based on user-configurable project criteria including at least one of a project cost criterion and a geographical criterion. In some embodiments, the representative metric is generated based on the filtered subset.

In some embodiments, the operations include generating an initial value of the predicted metric based on the configuration of the building equipment system and without using the project information. In some embodiments, the operations include adjusting the initial value of the predicted metric based on the project information to generate an adjusted value of the predicted metric.

In some embodiments, the operations include determining a statistical measure of the representative metric based on historical cost data associated with the set of historical building equipment installation projects. In some embodiments, the operations include displaying the statistical measure via the graphical user interface.

In some embodiments, at least one of the predicted metric or the representative metric comprises a plurality of sub-metrics including a labor metric, a materials metric, and an installation metric.

In some embodiments, the operations include identifying one or more required building equipment components missing from the selected subset. In some embodiments, the operations include adjusting the configuration of the building equipment system by adding the one or more required building equipment components to the selected subset.

Another implementation of the present disclosure is a method for configuring a building equipment system. In some embodiments, the method includes receiving a first user input including project information including an attribute of a prospective building equipment installation project. In some embodiments, the method includes obtaining equipment configuration data for a plurality of building equipment components capable of being included in the building equipment system based on the project information, receiving a second user input including a selected subset of the plurality of building equipment components, the selected subset defining a configuration of the building equipment system. In some embodiments, the method includes generating a predicted metric of the building equipment system based on the project information and the configuration of the building equipment system. In some embodiments, the method includes generating a representative metric of a set of historical building equipment installation projects that satisfy the attribute of the prospective building equipment installation project. In some embodiments, the method includes displaying the predicted metric of the building equipment system and the representative metric of the set of historical building equipment installation projects via a graphical user interface. In some embodiments, the method includes adjusting the configuration of the building equipment system based on the representative metric.

In some embodiments, the method includes communicating the project information to a machine learning system configured to use the project information and one or more patterns identified in the set of historical building equipment installation projects to determine at least one of the plurality of building equipment components capable of being used in the building equipment system.

In some embodiments, the project information includes at least one of a vertical market information, a project complexity information, a locale information, a start date information, and an end date information.

In some embodiments, the method includes receiving a third user input including equipment preferences including at least one of a controller preference, a variable frequency drive preference, an air handling unit preference, a damper preference, or an air flow monitoring station preference. In some embodiments, the equipment configuration data are obtained based on both the project information and the equipment preferences.

In some embodiments, the method includes filtering the set of historical building equipment installation projects to generate a filtered subset based on user-configurable project criteria including at least one of a project cost criterion and a geographical criterion. In some embodiments, the representative metric is generated based on the filtered subset.

In some embodiments, adjusting the configuration of the building equipment system includes automatically changing the selected subset of the plurality of building equipment components to decrease a difference between the predicted metric and the representative metric.

In some embodiments, the method includes determining a statistical measure of the representative metric based on historical cost data associated with the set of historical building equipment installation projects. In some embodiments, the method includes displaying the statistical measure via the graphical user interface.

Another implementation of the present disclosure is one or more non-transitory computer-readable storage media having instructions thereon that when executed by one or more processors, cause the one or more processors to receive a first user input including project information including an attribute of a prospective building equipment installation project. In some embodiments, the instructions cause the one or more processors to obtain equipment configuration data for a plurality of building equipment components capable of being included in a building equipment system based on the project information. In some embodiments, the instructions cause the one or more processors to receive a second user input including a selected subset of the plurality of building equipment components, the selected subset defining a configuration of the building equipment system. In some embodiments, the instructions cause the one or more processors to generate a predicted metric of the building equipment system based on the project information and the configuration of the building equipment system. In some embodiments, the instructions cause the one or more processors to generate a representative metric of a set of historical building equipment installation projects that satisfy the attribute of the prospective building equipment installation project. In some embodiments, the instructions cause the one or more processors to display the predicted metric of the building equipment system and the representative metric of the set of historical building equipment installation projects via a graphical user interface. In some embodiments, the instructions cause the one or more processors to adjust the configuration of the building equipment system based on the representative metric.

In some embodiments, the instructions cause the one or more processors to communicate the project information to a machine learning system configured to use the project information and one or more patterns identified in the set of historical building equipment installation projects to determine at least one of the plurality of building equipment components capable of being used in the building equipment system.

In some embodiments, the instructions cause the one or more processors to filter the set of historical building equipment installation projects to generate a filtered subset based on user-configurable project criteria including at least one of a project cost criterion and a geographical criterion. In some embodiments, the representative metric is generated based on the filtered sub set.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a central plant which can be used to serve the energy loads of the building of FIG. 1, according to some embodiments.

FIG. 3 is a block diagram of an airside system which can be implemented in the building of FIG. 1, according to some embodiments.

FIG. 4 is a block diagram of a building management system (BMS) which can be used to monitor and control the building of FIG. 1, according to some embodiments.

FIG. 5 is a block diagram of a building system configuration tool, according to some embodiments.

FIG. 6 is a flow diagram of a process for configuring a building equipment system, using the building system configuration tool of FIG. 5, according to some embodiments.

FIG. 7 is an example interface for the building equipment system configuration tool of FIG. 5, according to some embodiments.

FIG. 8 is the example interface of FIG. 7, showing example user selectable options, according to some embodiments.

FIG. 9 is an example interface for a building equipment system configuration tool of FIG. 5, according to some embodiments.

FIG. 10 is the example interface of FIG. 7, showing example user selectable options, according to some embodiments.

FIG. 11 is the example interface of FIG. 7, showing example selected user selectable options, according to some embodiments.

FIG. 12A is an example interface showing example system component options, a user configurable component table, a summary table, and other options, according to some embodiments.

FIG. 12B is an example interface showing example system estimate report, according to some embodiments.

FIG. 13 is an example interface showing an interface for updating user selectable options, according to some embodiments.

FIG. 14 is an example interface showing project budget information and a historical project budget, according to some embodiments.

FIG. 15 is an example interface showing historical project information, according to some embodiments.

FIG. 16 is the example interface of FIG. 15 with different historical project filter criteria, according to some embodiments.

### DETAILED DESCRIPTION

### Overview

Referring generally to the FIGURES, systems and methods for configuring a building equipment system (e.g., a building system) are shown, according to various exemplary embodiments. In some embodiments, a building equipment system configuration tool (e.g., a building system configuration tool) may be used by dealers, designers, engineers, and vendors of building equipment systems. A building equipment system configuration tool may receive and store various project metrics and component configuration data from current and prior building equipment system sales and installations, according to some embodiments. In some embodiments, the building equipment system configuration tool may receive inputs from a user to generate a budget, cost information, and other project metrics. In some embodiments, the generated budget is compared to a budget representative of historical projects having similar metrics as the metrics selected by the user. In some embodiments, a user may manipulate the representative historical project budget by interacting with filter criteria configured to filter the set of historical project data.

Typical building equipment configuration tools allow a user to interact with a static list of commercially available components, and generate a budget or other metrics based on the selected static list of components. The systems and methods described herein, according to some embodiments, allow a user to interact with a dynamic list of commercially available components and yet-to-be-designed components, generate a budget or other metric based on component selections from the dynamic list of components, and compare the budget or other metrics to historical project data. This comparison of an estimated project budget or other metric to historical project data having similar project metrics may advantageously allow a user to more consistently and accurately determine a suitable building system configuration and budget than otherwise possible.

### Building and HVAC System

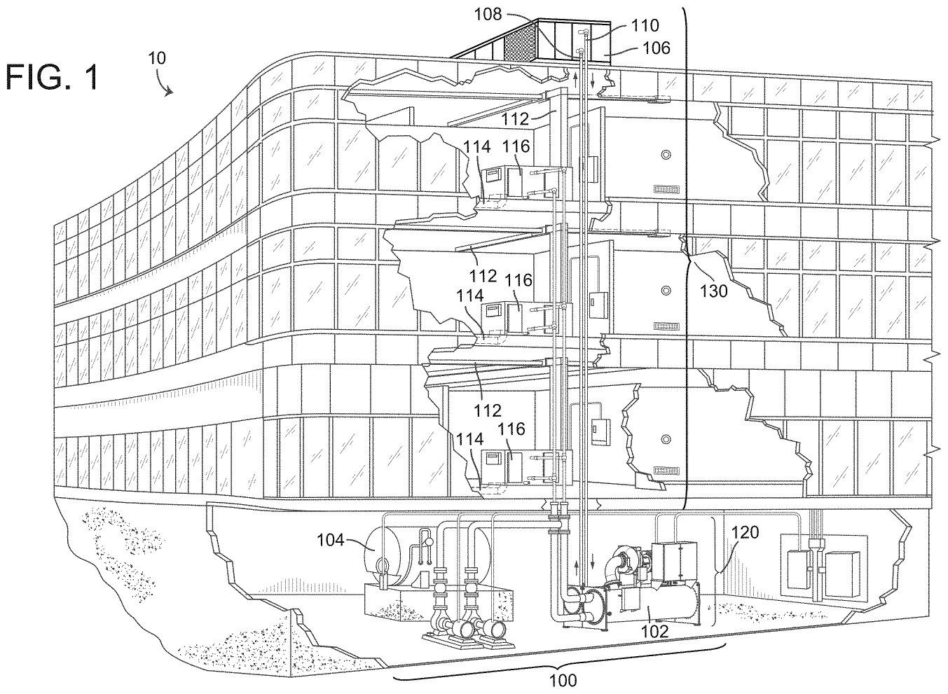

Referring now to FIG. 1, a perspective view of a building 10 is shown. Building 10 can be served by a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. An example of a BMS which can be used to monitor and control building 10 is described in U.S. patent application Ser. No. 14/717,593 filed May 20, 2015, the entire disclosure of which is incorporated by reference herein.

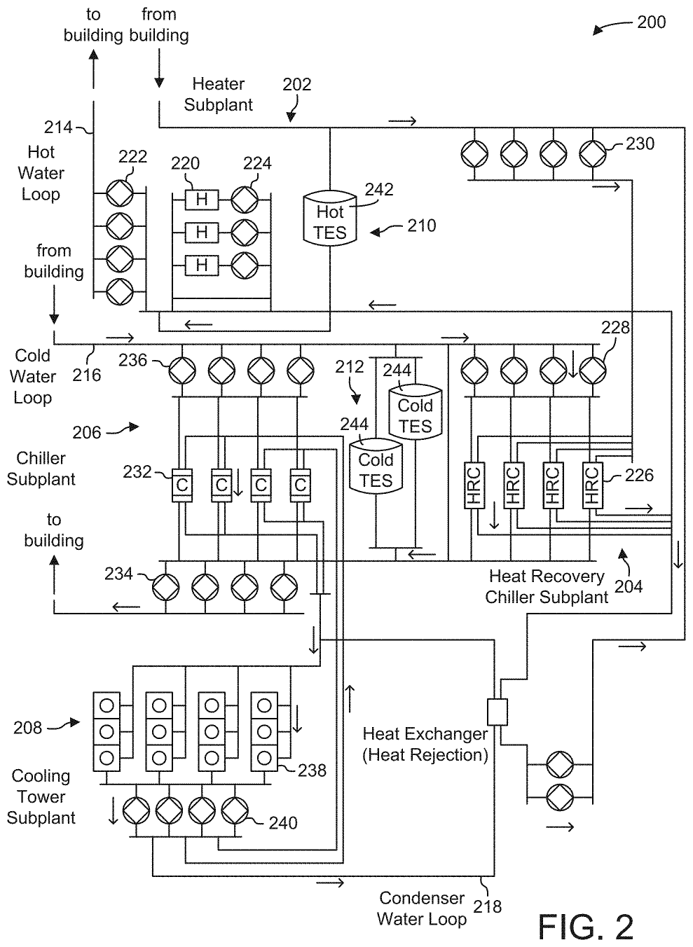

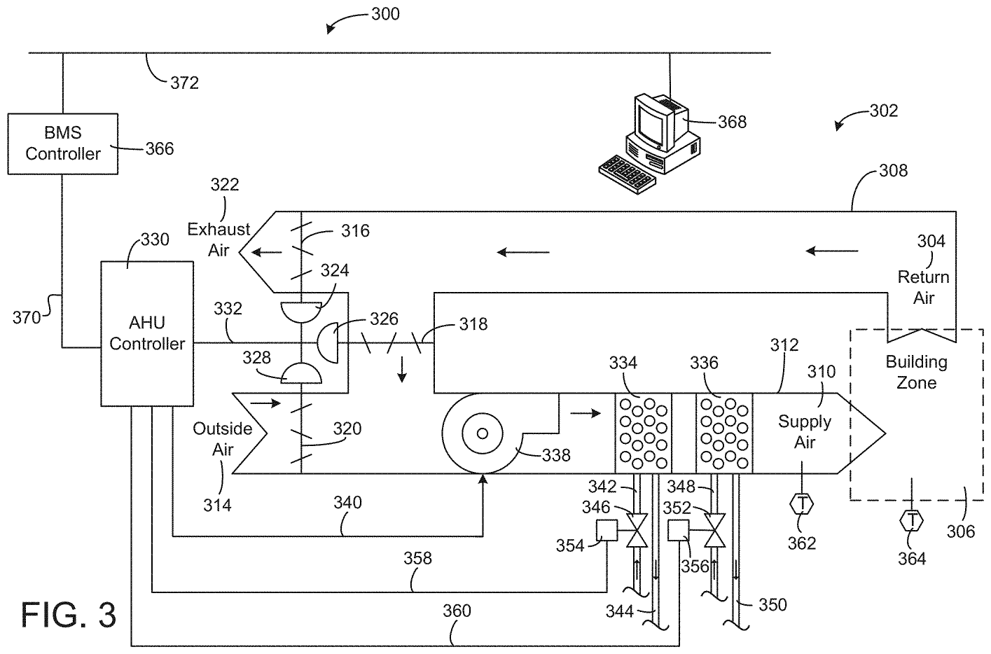

The BMS that serves building 10 may include a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 can be replaced with or supplemented by a central plant or central energy facility (described in greater detail with reference to FIG. 2). An example of an airside system which can be used in HVAC system 100 is described in greater detail with reference to FIG. 3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Central Plant

Referring now to FIG. 2, a block diagram of a central plant 200 is shown, according to some embodiments. In various embodiments, central plant 200 can supplement or replace waterside system 120 in HVAC system 100 or can be implemented separate from HVAC system 100. When implemented in HVAC system 100, central plant 200 can include a subset of the HVAC devices in HVAC system 100 (e.g., boiler 104, chiller 102, pumps, valves, etc.) and may operate to supply a heated or chilled fluid to AHU 106. The HVAC devices of central plant 200 can be located within building 10 (e.g., as components of waterside system 120) or at an offsite location such as a central energy facility that serves multiple buildings.

Central plant 200 is shown to include a plurality of subplants 202-208. Subplants 202-208 can be configured to convert energy or resource types (e.g., water, natural gas, electricity, etc.). For example, subplants 202-208 are shown to include a heater subplant 202, a heat recovery chiller subplant 204, a chiller subplant 206, and a cooling tower subplant 208. In some embodiments, subplants 202-208 consume resources purchased from utilities to serve the energy loads (e.g., hot water, cold water, electricity, etc.) of a building or campus. For example, heater subplant 202 can be configured to heat water in a hot water loop 214 that circulates the hot water between heater subplant 202 and building 10. Similarly, chiller subplant 206 can be configured to chill water in a cold water loop 216 that circulates the cold water between chiller subplant 206 building 10.

Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. In various embodiments, central plant 200 can include an electricity subplant (e.g., one or more electric generators) configured to generate electricity or any other type of subplant configured to convert energy or resource types.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-208 to receive further heating or cooling.

Although subplants 202-208 are shown and described as heating and cooling water for circulation to a building, it is understood that any other type of working fluid (e.g., glycol, CO₂, etc.) can be used in place of or in addition to water to serve thermal energy loads. In other embodiments, subplants 202-208 may provide heating and/or cooling directly to the building or campus without requiring an intermediate heat transfer fluid. These and other variations to central plant 200 are within the teachings of the present disclosure.

Each of subplants 202-208 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

In some embodiments, one or more of the pumps in central plant 200 (e.g., pumps 222, 224, 228, 230, 234, 236, and/or 240) or pipelines in central plant 200 include an isolation valve associated therewith. Isolation valves can be integrated with the pumps or positioned upstream or downstream of the pumps to control the fluid flows in central plant 200. In various embodiments, central plant 200 can include more, fewer, or different types of devices and/or subplants based on the particular configuration of central plant 200 and the types of loads served by central plant 200.

Still referring to FIG. 2, central plant 200 is shown to include hot thermal energy storage (TES) 210 and cold thermal energy storage (TES) 212. Hot TES 210 and cold TES 212 can be configured to store hot and cold thermal energy for subsequent use. For example, hot TES 210 can include one or more hot water storage tanks 242 configured to store the hot water generated by heater subplant 202 or heat recovery chiller subplant 204. Hot TES 210 may also include one or more pumps or valves configured to control the flow rate of the hot water into or out of hot TES tank 242.

Similarly, cold TES 212 can include one or more cold water storage tanks 244 configured to store the cold water generated by chiller subplant 206 or heat recovery chiller subplant 204. Cold TES 212 may also include one or more pumps or valves configured to control the flow rate of the cold water into or out of cold TES tanks 244. In some embodiments, central plant 200 includes electrical energy storage (e.g., one or more batteries) or any other type of device configured to store resources. The stored resources can be purchased from utilities, generated by central plant 200, or otherwise obtained from any source.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by central plant 200.

Airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from central plant 200 (e.g., from cold water loop 216) via piping 342 and may return the chilled fluid to central plant 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from central plant 200 (e.g., from hot water loop 214) via piping 348 and may return the heated fluid to central plant 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, central plant 200, HVAC system 100, and/or other controllable systems that serve building 10. BMS controller 366 may communicate with multiple downstream building systems or subsystems (e.g., HVAC system 100, a security system, a lighting system, central plant 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

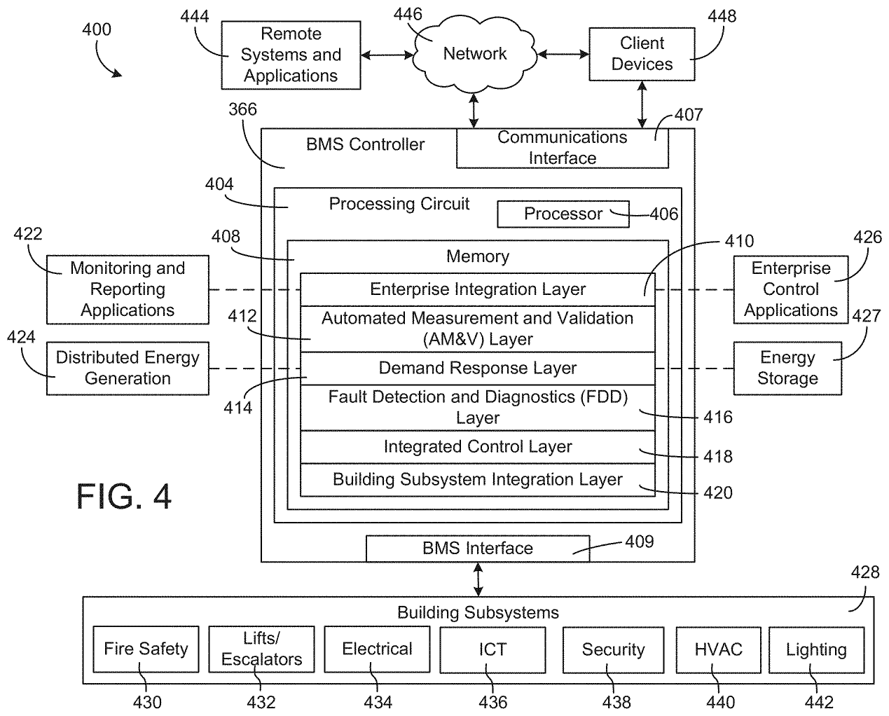

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and building subsystems 428 and can be implemented using servers (e.g., cloud-based platform) or one or more thermostats (e.g., thermostat 107 FIG. 1)). Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Building Equipment System Configuration and Budget Tool

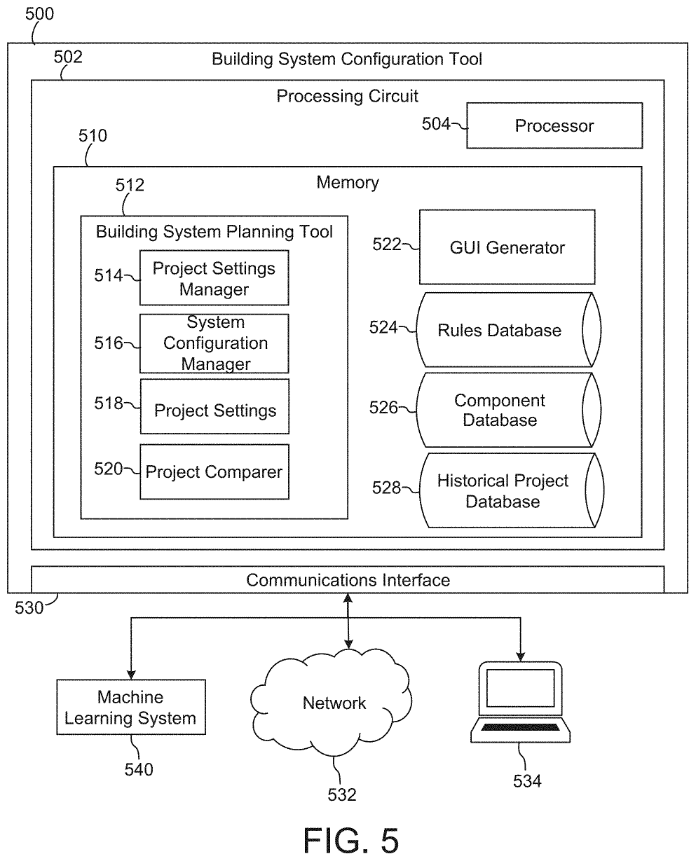

Referring now to FIG. 5, a block diagram of a building system configuration tool 500 is shown, according to some embodiments. Building system configuration tool 500 is generally configured to allow a user to configure a building equipment system and determine a building system plan based on one or more user inputs and/or other configuration parameters. Specifically, building system configuration tool 500 may be configured to directly receive large-scale project inputs including market information (e.g., vertical market information), project complexity information (e.g., project management complexity, building complexity, etc.), project location information (e.g., city, state, region, etc.), project start date and end date information, and other large scale inputs, to determine a list of building system components that may be suitable for the large-scale user inputs selected by the user. In some embodiments, the large-scale inputs include floor plans, local map data, computerized design files, customer specific information, and other large-scale project information.

Building system configuration tool 500 is shown to include a processing circuit 502 that further includes a processor 504 and a memory 510. While shown as single components, it will be appreciated that processor 504 and/or memory 510 may include multiple components (e.g., multiple processors or multiple memory devices). In some embodiments, memory 510 may be a local or remote memory. Likewise, in some embodiments, building system configuration tool 500 itself is implemented within a single computer (e.g., one server, one housing, etc.) or can be distributed across multiple servers or computers (e.g. that can exist in distributed locations). In some such embodiments, the distributed serves or computers are communicably coupled via network 532, described in greater detail below. All such implementations are contemplated herein.

Processor 504 can be implemented as a general purpose processor, an application specific integrated circuit (ASIC), or more field programmable gate arrays (FPGAs), a group of processing components, or other suitable electronic processing components. Memory 510 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 510 can be or include volatile memory or non-volatile memory. Memory 510 can include database components, object code components, script components, or any other type of information structure for supporting the various activities and information structures described in the present application. According to an example embodiment, memory 510 is communicably connected to processor 504 via processing circuit 502 and includes computer code for executing (e.g., by processing circuit 502 and/or processor 504) one or more processes described herein.

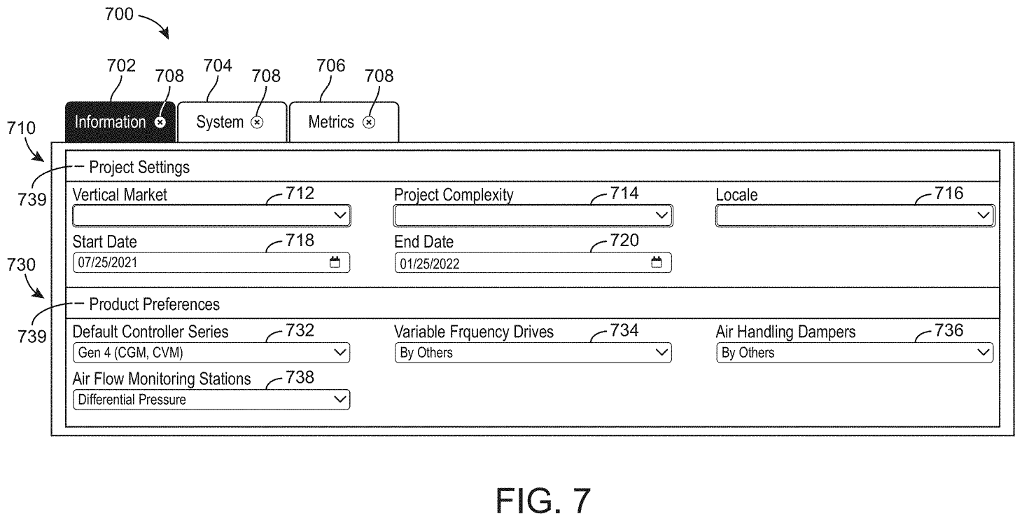

Memory 510 is shown to include a building system planning tool 512 configured to determine a budget for a building system configuration, and a representative budget based on historical project information. More specifically, building system planning tool 512 may be configured to manage information input by a user, and also manage information stored within memory 510 to determine an estimated building system budget. In some embodiments, building system planning tool 512 is configured to optimize a building system budget based on user input information and historical project data. As shown in FIG. 5, building system planning tool 512 includes a project settings manager 514, a system configuration manager 516, a project estimator 518, and a project comparer 520. Various functions of these components are described in detail with reference to FIGS. 7-16. But before doing so, a high level overview of each of these components is provided below.

In some embodiments, project settings manager 514 is configured to receive large-scale inputs from a user. Project settings manager 514 may compile large-scale inputs which may be used to filter building system data stored in memory 510. In some embodiments, project settings manager 514 is configured to generate large-scale user input fields available to the user based on other large-scale user inputs entered by the user. In some embodiments, project settings manager 514 is configured to determine a value of a variable used in a cost function associated with large-scale inputs (e.g., a tuning factor, a scalar, a multiplier, etc.). In some embodiments, large-scale inputs are processed by processing circuit 502 and sent to machine learning system 540 as training information.

In some embodiments, system configuration manager 516 may be configured to receive user preferences (e.g., system component preferences, system preferences, etc.), and may also be configured to receive secondary user preferences and user component selections. In some embodiments, system configuration manager 516 may access component database 526 to obtain a list of available components and associated equipment configuration data (e.g., labor costs, material costs, installation costs, sell prices, complexity quantifiers, etc.). System configuration manager 516 may also be configured to filter a preexisting list of components stored within component database 526, or may dynamically generate new components or new combinations of components though communications with machine learning system 540.

In some embodiments, system configuration manager 516 may be configured to allow the user to select particular types of components or functionality of the building equipment system, rather than selecting particular components. For example, a user could specify that they want the building system to have an AHU (e.g., AHU 106) having an air flow rate of 20,000-30,000 CFM, or the user could simply indicate that they want an AHU without defining a flow rate. As another example, a user may specify that they want the building system to have a wireless networking system, without specifying a specific wireless network system component. In some embodiments, the system configuration manager 516 may automatically identify suitable components based on these parameters (e.g., component type, component functionality, etc.) and large-scale parameters defined by a user. In some embodiments, system configuration manager 516 can estimate labor costs by obtaining (e.g., from a remote system) live or updated cost data from contractors, installers, etc. For example, system configuration manager 516 may query an online database to identify a current hourly rate and duration for installing a component of the building system, which can be used to estimate the labor cost for installing a component of a building equipment system. For example, each component of the building equipment system may be associated with a predetermined number of installation hours, hardware engineering hours, software engineering hours, project management hours, and other hours which can be used to estimate hourly costs based on current hourly pricing (e.g., a two hour installation at $200/hour would cost $400). In some embodiments, the hourly rate is an effective hourly rate for a group of hourly rates. For example, a hardware engineering rate and a software engineering hourly rate may be combined in an effective engineering hourly rate, according to some embodiments.

In some embodiments, labor costs include a cost estimate for preparing a worksite for installation of the building equipment system. For example, labor costs may include costs for removing (e.g., uninstalling) an existing building management system. In some embodiments, system configuration manger 516 may be configured to estimate a cost of disposing of and/or recycling the removed building equipment. For example, a building system may be removed for being undersized for a building, and components of the building system may be recycled, resold, repurposed, etc. or disposed of (e.g., scrapped, melted, etc.) and a cost may be incurred for removing the components of the building equipment system. In some embodiments, fees for removing and transporting the removed building equipment system may be included in the labor cost category. In some embodiments, an estimation of the costs associated with removing the existing building equipment system are included in a cost category separate from labor costs. In some embodiments, the system configuration manager 516 considers (e.g., accounts for) a salvage value of the equipment being removed. For example, an AHU may have a salvage value that is half of the original purchase price of the AHU which may offset some or all of the costs associated with removing and uninstalling the AHU. In some embodiments, information tab 702 includes fields for a user to enter information about an existing building equipment system. In some embodiments, the complexity added to the project by the existing building equipment system (e.g., removal costs, added project duration, added project planning costs, additional labor costs, waste disposal services involvement, etc.) is accounted for by project complexity information 714.

In some embodiments, system configuration manager 516 is configured to identify missing equipment that is not selected by the user. For example, a user may fail to select one or more components of a typically selected combination of components, such as a typical combination of a networking system, air handling unit, and central plant. System configuration manager 516 may automatically add a network system to a user selected central plant system and air handling unit to complete the typical combination of selected components. In some embodiments, system configuration manager 516 is configured to automatically add supporting components to the selected component list based on components selected by the user. For example, a user may select a AHU, and system configuration manager 516 may automatically add the necessary hardware components (e.g., standard or typical lengths of electrical wires) for the selected component to be installed. In some embodiments, the supporting components are not directly viewable or selectable by the user.

In some embodiments, project estimator 518 is configured to determine an estimated budget and a sale price for a system selected though system configuration manager 516. In some embodiments, project estimator 518 is configured to manage inputs from a user to adjust specific component information (e.g., margin, adjustment percentages, etc.) for the set of components selected by system configuration manager 516. In some embodiments, project estimator 518 is configured to identify missing and/or redundant building system components selected by a user. For example, if a user selects five central plant systems, project estimator 518 may indicate that five central plant systems have been selected and ask the user for confirmation. In some embodiments, project estimator 518 is configured to compute one or more cost functions (e.g., a summation of the total costs for each component). In some embodiments, project estimator 518 is configured to receive user inputs to adjust stored component data (e.g., installation hours, sell price, material cost, etc.). In some embodiments, project estimator 518 sends user inputs to adjust stored component data to machine learning system 540 as component specific training data. In some embodiments, the machine learning system 540 may receive actual component cost information (e.g., component purchase prices, sell prices, etc.) to reinforce patterns identified by the machine learning system 540.

In some embodiments, project comparer 520 is configured to compare the project data (e.g., components, vertical market information, locale information, etc.) and the budget determined by project estimator 518 to one or more historical projects stored in historical project database 528. In some embodiments, project comparer 520 is configured to determine a representative project (e.g., averaged project based on costs, averaged project based on number and kind of components used, averaged project based on duration of the project, averaged project based on locale, etc.) based on historical project data stored in historical project database 528. In some embodiments, project comparer 520 is configured to determine a statistical measure of a representative building system project (e.g., an average project based on historical project data) determined by the project comparer 520 in view of the historical project information stored in the historical project database 528. In some embodiments, project comparer 520 may determine the confidence level or probability that the representative project determined by project comparer 520 is a reliable representation of the population of historical project data.

In some embodiments, project comparer 520 determines one or more statistical measure based on a representative budget that is representative of a filtered subset of stored building system project data stored in historical project database 528. In some embodiments, the user supplies the filter criteria. In some embodiments, project comparer 520 automatically generates the filter criteria based on user inputs. In some embodiments, the filter criteria is supplied by the user in combination with the automatically generated filter criteria. For example, project comparer 520 may determine an averaged budget and associated budget breakdown percentages for a set of historical project data that falls within a desirable range of the estimated budget determined by the project estimator 518 (e.g., ±$5,000 of total cost, etc.). In some embodiments, the user may select the desirable range and other filter criteria (e.g., large-scale factors, product preference information, geographical information, price, etc.) for determining the representative budget. In some embodiments, project comparer 520 determines a confidence level of the representative budget relative to the overall population of budget data. In some embodiments, project comparer 520 determines a confidence level of a representative budget relative to a filtered subset of budget data from the population of budget data. In some embodiments, the confidence level and other similar measures (e.g., sample size, population size, standard deviation, variance, etc.) of set of budget data is displayed to the user. In some embodiments, the statistical measures are displayed graphically on a display on a user device 534 showing a graphical user interface. In some embodiments, the graphical user interface is generated and managed by graphical user interface (GUI) generator 522.

In some embodiments, rules database 524 maintains a plethora of rules that dictate possible combinations of building components, and other rules for the building system planning tool 512. In some embodiments, rules database 524 is configured to maintain rules for modifying budget information when a combination of building components are selected. For example, rules database 524 may maintain rules that modify an installation cost and labor cost of individual components when one or more of a number of specified components are selected. More specifically, in such example, if two air handling units are selected, and they are planned to be delivered to the same worksite, the installation costs may be adjusted (e.g., reduced) for each of the air handling units to account for the reduction in installation costs (e.g., the air handling units can be installed by a single crane), labor costs (e.g., the installation crew would already be on the worksite and have the proper tools), or other efficiencies that result from a shared worksite or labor force. In some embodiments, rules database 524 may maintain rules that are accessed and modified by project settings manager 514, system configuration manager 516, project estimator 518, and project comparer 520. For example, rules database 524 may maintain rules for project settings manager 514 which cause building system planning tool 512 to selectively allow a user to input information only if specific input requirements have been met (e.g., a user may only provide component selection information after large-scale inputs are received).

In some embodiments, rules database 524 is periodically updated or continuously updated by an artificial intelligence (AI), shown as machine learning system 540. In some embodiments, machine learning system 540 may receive budget estimates, and the associated user inputs and user selections, as training data. In some embodiments, machine learning system 540 receives an input from the user after a quoted project has been completed which may function as reinforcement in a reinforcement machine learning approach. In some embodiments, machine learning system 540 is configured to create a model such as an artificial neural network (ANN), decision tree model, a support-vector machine, a regression analysis, Bayesian network, or other machine learning models known in the art. Various inputs may be supplied to the model as described herein.

In some embodiments, the machine learning system 540 manipulates rules stored in rules database 524 to improve the accuracy of building system planning tool 512 over time. For example, machine learning system 540 may identify patterns in commonly selected combinations of components which are determined to be over budget. The machine learning system may then adjust rules stored in rules database 524 and equipment configuration data stored in component database 526 to improve the accuracy of the building system planning tool 512.

In some embodiments, memory 510 can also include a graphical user interface generator (GUI) generator 522 configured to generate graphical user interfaces (GUIs). These GUIs can provide any sort of information, both text-based and visually, to a user via user device 534, for example. Example GUIs shown below with respect to FIGS. 7-16 can include a configuration interface that allows a user to input parameters for configuring and designing a building equipment system. In some embodiments, GUI generator 522 can also present interfaces that provide 2D or 3D models, which may represent augmented reality arrangements of selected components on a work site, budget information, and other graphical representative displays of the building system configuration tool 500 and building system planning tool 512.

In some embodiments, memory 510 includes a component database 526 configured to store parameters and information for a wide variety of possible building equipment system components, such as sell prices, labor cost information, material cost information, installation cost information, product configuration information (e.g., type of air handling unit, air flow rate, damper settings, controller settings, etc.). In some embodiments, component database 526 is regularly or continuously updated with data from remote systems (e.g., product manufacturer databases, retail databases, cost databases, etc.), via network 532 and/or data from machine learning system 540. In some embodiments, component database 526 includes preconfigured building equipment system component relationships and combinations.

In some embodiments, memory 510 includes a historical project database 528 configured to store historical project data. In some embodiments, the historical project data is a set of previous budgets generated by the building system planning tool 512. In some embodiments, the set of historical budgets is a set of manually entered budgets from past projects. In some embodiments, the set of historical budgets is a combination of previous budgets generated by the building system planning tool 512 and manually entered budgets from past projects. In some embodiments, historical project database stores equipment configuration data. In some embodiments, equipment configuration data is a product weight, power requirement information, performance information (e.g., power curves, rise times, sensitivities, etc.), component input information, component output information, reliability information, maintenance schedules, product dimensions (e.g., length, width, height, etc.), various connection and coupler requirements (e.g., mechanical couplers, electronic couplers, controls circuit requirements, etc.), and still other suitable configuration data for designing a building system using the component.

In some embodiments, historical project database 528 is partially or fully populated by machine learning system 540. For example, a historical budget may be missing several categories of information (e.g., labor costs, engineering hours, etc.) and machine learning system 540 may identify one or more patterns in the historical budget data to artificially populate the missing fields. In some embodiments, historical project database 528 receives updated project information from network 532 and may supply historical budget information to machine learning system 540. In some embodiments, historical project database 528 provides historical budget information to project comparer 520. Although machine learning system 540 is shown as separate from building system configuration tool 500 in FIG. 5, it should be understood that machine learning system 540 may be a component of building system configuration tool 500 and/or building system planning tool 512 in some embodiments.

In some embodiments, the historical project database 528 includes data that includes a plethora of historical project information attributes including a historical project's vertical market information 712, locale information 716, complexity information 714, product preferences 730, components used, components selected, client information, payment information, billing information, profit margins, estimated project duration, actual project duration, contractors and subcontractors used, components selected for the estimate, components actually installed on the worksite, labor rates, equipment costs, installation costs, engineering notes, installer notes, and other project specific information. In some embodiments, historical project database 528 is configured to store all data associated with the project that is in a digital form and readable by a computer (e.g., scanned documents, digital photographs, spreadsheets, contact information, project email history, worksite videos, project progress videos, etc.) and may use known or new methods to extract useful project information from the raw project data (e.g., optical character recognition, image recognition, etc.). In some embodiments, historical project database 528 is configured to filter projects that are not typical of projects within historical project database 528 (e.g., outliers such as misquoted jobs, natural disasters, charity, etc.). In some embodiments, the system is filtered based on user selected criteria, as described further with respect to FIGS. 7-16.

Still referring to FIG. 5, building system configuration tool 500 is shown to include a communications interface 530 for facilitating communications between building system configuration tool 500 and any number of external devices or system. As shown, for example, interface 130 can facilitate communications between building system configuration tool 500, network 532, user device 534, and machine learning system 540, as described in greater detail below. Interface 530 can be or can include wired or wireless communications interfaces (e.g., jacks, antennas, transmitters, receivers, transceivers, wire terminals, etc.) for conducting data communications. In some embodiments, communications via interface 530 can be direct (e.g., local wired or wireless communications) or via a communications network (e.g., a WAN, the Internet, a cellular network, etc.). For example, interface 530 can include an Ethernet card and port for sending and receiving data via an Ethernet-based communications link or network. In another example, interface 530 can include a Wi-Fi transceiver for communicating via a wireless communications network. In another example, interface 530 can include cellular or mobile phone communications transceivers. In one embodiment, interface 530 is a power line communications interface.

In various embodiments, network 532 is any suitable network for transmitting and receiving data with remote devices and systems. For example, network 532 may be any type of intranet or internet such as a local area network (LAN), a wide area network (WAN), a virtual private network (VPN), etc. In some embodiments, any number of other remote systems or devices may be communicably coupled to network 532 such that the remote systems and devices may communicate with building system configuration tool 500. As an example, a remote server or computing system may be coupled to network 532 and may handle a portion of the processing or storage required by building system configuration tool 500.

User device 534 may be any electronic device that allows a user to interact with building system configuration tool 500, such as through a user interface. Examples of user devices include, but are not limited to, mobile phones, electronic tablets, laptops, desktop computers, workstations, and other types of electronic devices. Accordingly, user device 534 generally includes a user input device such, such as a keyboard, a touchscreen display, a keypad, buttons, switches, etc. User device 534 may present a graphical user interface on a display and receive user input via the user input device, thereby enabling a user to easily and intuitively interact with building system configuration tool 500.

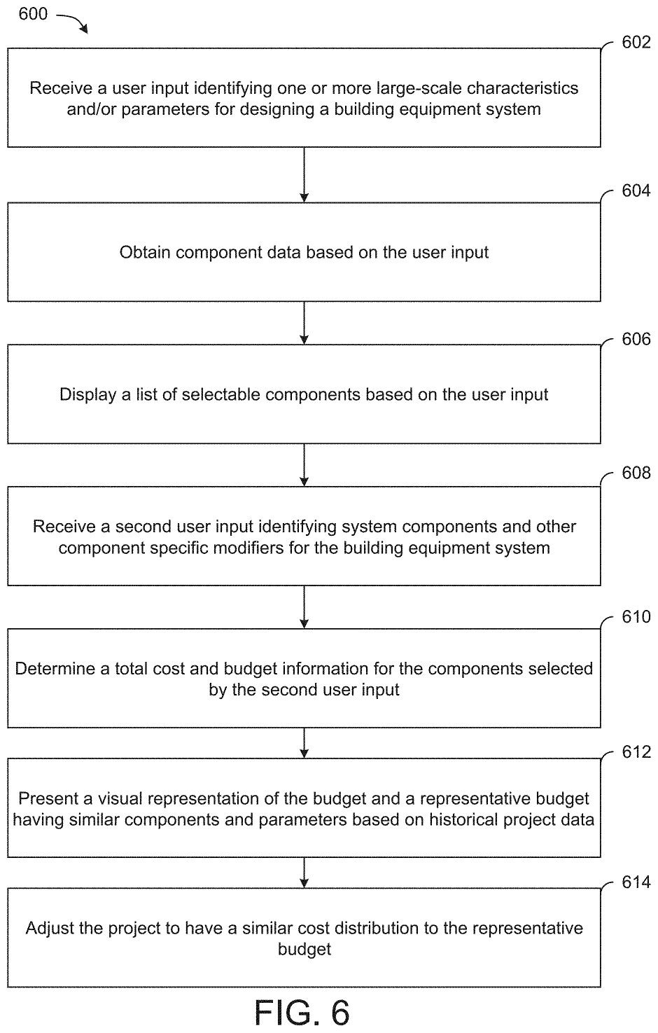

Referring now to FIG. 6, a flow diagram of a process 600 for configuring a building equipment system is shown. Process 600 may be performed by one or more components of building system configuration tool 500 and/or other components shown in FIG. 5, in some embodiments. Various examples of user interfaces that can be generated and presented to a user to facilitate some or all of the steps of process 600 are described in greater detail below with reference to FIGS. 7-16. Process 600 is shown to include receiving a user input identifying one or more large-scale characteristics and or parameters for designing a building equipment system (step 602), obtaining component data based on the user input (step 604), displaying a list of selectable components based on the user input (step 606), receiving a second user input identifying system components and other component specific modifiers for the building equipment system (step 608), determining a total cost and budget information for the components selected by the second user input (step 610), presenting a visual representation of the budget and a representative budget having similar components and parameters based on historical budget data (step 612), adjusting the budget to have a similar cost distribution to the representative budget (step 614).

At step 602, a user input selecting or entering one or more large-scale characteristics and/or parameters for designing a building equipment system is received by a building system configuration tool 500. In some embodiments, the large-scale characteristics include project settings such as vertical market information, project complexity information, locale information, a project start date, and a project end date, etc. In some embodiments, the large-scale characteristics include product preference information such as manufacturer preferences, signal preferences, valve type preferences, controller preferences, etc. In some embodiments, these inputs are managed by at least the project settings manager 514.

At step 604, component data is obtained based on the user input. Specifically, a database (e.g., component database 526) or remote system may be queried to identify components for populating the building system configuration tool 500 that meet the large-scale characteristics and large-scale parameters entered by the user. For example, if a user chooses to only include systems having a 4^{th} generation controller, a database may be queried to identify possible components including a 4^{th} generation controller or combatable with a 4^{th} generation controller. In some embodiments, upon a component or plurality of components being identified, component data such as the sell price, labor costs, material costs, installation costs, and a total cost may be identified and populated within the building system planning tool 512. In some embodiments, the component database 526 is queried to identify components that meet the large-scale characteristics and large-scale parameters entered by the user.

At step 606, the building system configuration tool 500 displays a list of selectable components based on the user input. In some embodiments, the identified components in step 604 (e.g., the components meeting the large-scale criteria and user preference parameters) are displayed as a list. In such embodiments, the list may display select configuration specific information for consideration by the user. For example, the system may display a list of viable air handling units, central plant systems, miscellaneous systems, terminal unit systems, network systems, with each showing select configuration specific information (e.g., CFM and controller type). In some embodiments, the components displayed in the list do not correspond to tangible and readily accessible products, and may relate to features or combinations of features that are desired to be engineered into existence. In some embodiments, the components displayed that do not correspond to tangible and readily accessible projects are features or combinations of features that are generated by the machine learning system 540.

At step 608, the building system configuration tool 500 receives a second user input identifying system components and other component specific modifiers for the building equipment system. In some embodiments, a user may select one or more items from the list generated during step 606 (e.g., by a drag and drop, by a check box interface, etc.) to create a list of selected components. The list of selected components may include component-specific budget information (e.g., labor costs, material costs, installation costs, etc.).

At step 610, the building system configuration tool 500 determines a total cost and budget information for the components selected by the second user input. In some embodiments, system configuration manager 516 retrieves component budget data from component database 526 for the components in the list of selected components generated during step 608. In such embodiments, project estimator 518 may determine one or more costs of the list components selected by the user.

At step 612, the building system configuration tool 500 presents a visual representation of the budget determined during step 610 and a representative budget having similar components and parameters based on historical budget data. In some embodiments, the visual representation may be one or more of a graphic, table, chart, numeral, or text which indicates a budget and a representative budget based on historical budget data. The representative budget may be determined by the project comparer 520 based on the user input of steps 602 and historical budget data stored in historical project database 528. In some embodiments, the representative budget can be tuned by the user interacting with criteria settings which modify the filter parameters used by project comparer 520 to generate the representative budget. In some embodiments, the criteria are modified to narrow or broaden the set of historical project data filtered by the project comparer 520. In some embodiments, the project comparer 520 automatically adjusts one or more criteria to achieve a desirable threshold of a statistical measure. For example, project comparer 520 may automatically adjust criteria settings from default settings to increase the sample size, achieve a confidence level, and/or modify the average representative project (e.g., average budget, etc.).

At step 614, the building system configuration tool 500 or the user adjusts the current project (e.g., selected system components, product preferences, etc.) to have similar metrics to the representative project. In some embodiments, the user may select different building system components (e.g., a different AHU, a different combination of components, etc.), modify component specific parameters (e.g., installation costs, material costs, etc.), or fine tune the project (e.g., identify and remove suboptimal combinations of components, identify and include optimal or preferable combinations of components) to adjust the project to have similar metrics to the representative project. In some embodiments, the process 600 may repeat starting at step 602, or step 608. In some embodiments, a user may decide to not adjust the project to have similar metrics (e.g., budget, cost distribution, etc.) to the representative project. For example, a user may decide to not adjust the project if the representative project is indicated being an unreliable representation of the historical budget data stored in historical project database 528 (e.g., has a low confidence level), according to some embodiments.

Referring now to FIG. 7-16, various user interfaces for interacting with a building system configuration tool 500 is shown, according to some embodiments. Referring specifically to FIG. 7, user interface 700 includes a first tab, shown as information tab 702, a second tab, shown as system tab 704, and a third tab, shown as metrics tab 706. In some embodiments, information tab 702, system tab 704, and metrics tab 706 include a status identifier 708. Status identifier 708 may indicate if a user has entered the required data on each tab 702, 704, 706 to generate a representative budget based on information provided to the building system configuration tool 500. For example, as shown in FIG. 7, a user inputs large-scale project information, shown as project settings 710 to meet the requirements of information tab 702.

In some embodiments, project settings 710 includes vertical market information 712 (e.g., health care, higher education, real estate offices, financial offices, K12 schools, local government, federal markets, military markets, airport markets, transportation markets, etc.), project complexity information 714 (e.g., simple, average, complex, very complex, etc.), locale information 716 (e.g., geographical location, region, district, etc.), a project start date, shown as start date 718, and a project end date, shown as end date 720. In some embodiments, project settings 710 includes other large-scale information such as client specific product information, dealer information, political climate, global supplier status information (e.g., shortages due to a global pandemic), etc.

In some embodiments, each project setting 710 has one or more corresponding tuning factor for each cost calculated by the building system planning tool 512. In some embodiments, the tuning factor is a “simple” tuning factor, and is a scalar quantity or a multiplier applied to one or more components available for selection by the user. The tuning factor may be included in a cost function to account for otherwise unquantifiable project costs associated with each project setting 710.

In some embodiments, a tuning factor associated with project settings 710 may represent complexities of different vertical markets (e.g., healthcare, education, etc.), having varying requirements, codes, and standards. For example, a user may select a “healthcare” vertical market, which may, for example, have a tuning factor of 110%, which would represent the costs of installing and designing a HVAC system in view of the comparatively strict standards and design considerations of HVAC systems in a healthcare setting, as compared to a “baseline” vertical market (e.g., education) having comparatively lax standards and design considerations. For example, a project in a healthcare vertical market may require strict air filtering requirements and specific air exchange rates to prevent the distribution of air contaminants (e.g., disease) throughout the building via the HVAC equipment, which may contribute to a comparatively higher cost than other vertical markets, and thus a comparatively higher budget estimate. In some embodiments, the tuning factor associated with vertical market information 712 may represent typical margins for building systems.

In some embodiments, project complexity information 714 is used to help determine the product management costs associated with a building equipment system. For example, project management costs associated with a worksite in a prison have significantly more costs and complexity (e.g., security considerations, limited access, locked doors, etc.) than a less complex worksite such as an elementary school which has numerous entrances and exits, and accessible parking and material holding locations.

In some embodiments, project complexity information 714 is determined as project management costs associated with an anticipated jobsite, and may be a cost scalar or multiplier (e.g., 110%, 120%, 90%, etc.). For example, if a jobsite is only accessible by an elevator (e.g., in a high-rise, in a skyscraper, in a tall building, etc.) and is located in a downtown of a large city with limited parking and material holding locations, project management costs may be more significant than for a jobsite located at a single-floor building with multiple entrances and exits and plentiful parking and material holding locations. In such example, the variance in project management complexity may be accounted for through adjustments at the project settings 710 level (e.g., through project complexity information 714). In some embodiments, project complexity information 714 is determined using a number of project complexity factors (e.g., type of building, location, anticipated scheduling conflicts, installation system requirements such as crane rentals and scaffolding requirements, etc.).

In some embodiments, locale information 716 sets local labor rates for the building system planning tool 512. In some embodiments, the building system configuration tool 500 retrieves labor rates (e.g., engineering rates, installation rates, etc.) stored within component database 526 to populate a portion of a cost function based on the locale information 716 selected by the user. In some embodiments, the labor rates are stored within component database 526. In some embodiments, the labor rates stored within a database other than component database 526. In some embodiments, labor rates are updated regularly over network 532 to reflect current labor rates and installation costs in the geographical areas selectable by the user. In some embodiments, component database 526 stores a set of default (e.g., baseline) labor rates. In some embodiments, the default labor rates are an average of labor rates over one or more geographical locations selectable by the user. For example, default labor rates stored in component database 526 may be an average of labor rates attributed to each of the geographical locations selectable by the user. In such example, project estimator 518 may indicate whether a selected locale has a higher than average labor rate or a lower than average labor rate, which may ultimately aid a user in understanding and interpreting disparities in cost estimates having differing locale information 716. In some embodiments, labor rates are compared based on a labor category basis (e.g., engineering labor rates, electrical installation labor rates, equipment installation labor rates, etc.). In some embodiments, labor rates are compared on an effective or combined labor rate basis (e.g., a cumulative labor rate basis).

In some embodiments, labor rates for each locale selectable by the user are determined using approximation techniques (e.g., interpolation or extrapolation) between geographical locations with known labor rates (e.g., recently updated labor rates, reported labor rates). For example, if it is known that labor rates are correlated with a proximity to a location of high population density (e.g., a downtown, a large city, etc.), locations of varying proximity to the location of high population density may be approximated using two or more known labor rates. For example, if the labor rate is known for the location of high population density and also for a second location at a known distance from the location of high population density, the system configuration manager 516 may interpolate to determine a labor rate at a location between the location of high population density and the second location, and may extrapolate to determine a labor rate at a location further from the location of high population density than the second location. For example, if a labor rate for the location of high population density is $100 per hour, and the labor rate at a second location 10 miles away from the location of high population density is $50 per hour, the system configuration manager 516 may determine that the labor rate at a location 5 miles away from the location of high population density is $75 per hour using interpolation, and that a labor rate at a location 15 miles away from the location of high population density is $25 per hour. It is worth noting that although the prior example appears to be a simple relationship (e.g., a linear relationship) between labor rates and a proximity to a location of high population density, the methods of approximating labor rates may include complex relationships (e.g., non-linear relationships, multivariable equations relating several factors, etc.).

In some embodiments, machine learning system 540 receives a set of labor rates for a number of locations, and creates a number of labor rate approximations for locations without known labor rates using various “test” patterns (e.g., predicted relationships between labor rates and population density, predicted relationships between geographical location and proximity to major bodies of water, etc.). In such embodiments, the machine learning system 540 may receive additional labor rate information which may have been successfully or unsuccessfully predicted based on the test patterns generated by the machine learning system 540. The patterns which contributed to (or caused) the accurate approximations of labor rates may be “reinforced” and used as part of future “test” patterns. In some embodiments, machine learning system 540 ultimately communicates the reinforced patterns to the system configuration manager 516 to update the methods used for approximating labor rates used by the building system planning tool 512. The system configuration manager 516 may then use the reinforced patterns to update the labor rates stored in the component database 526. Although the method described above pertains to labor rates, similar methods involving “test” patterns may be generated and selectively reinforced by the machine learning system 540 for various goals and values (e.g., tuning factors, component cost data, etc.).

In some embodiments, the locale information 716 is used to determine tax rates. The tax rates may vary by geographical location, and are stored in memory 510. The tax rates may be updated periodically or continuously via network 532. In some embodiments, select components stored in the component database 526 have additional taxes or other regulatory costs associated with the component based on locale information 716. For example, a component planned to be installed in a location with strict environmental codes and regulations (e.g., efficiency requirements, etc.), may require payment of an additional tax or fee, which may be added to systems that include the components that do not meet the environmental codes and regulations.

In some embodiments, a user may input locale information 716 via a direct input to the user interface 700. In some embodiments, the system configuration manager 716 may use a location determining technique to automatically populate locale information 716. In some embodiments, the locale information is generated automatically based on a global positioning service (GPS) and global positioning service hardware in communication with the processing circuit 502 via the communications interface 530. In some embodiments, the locale information 716 is automatically populated based on a user's internet protocol (IP) address. For example, a user may enable location services to allow the users IP address to be communicated to a geolocation application programing interface (API) which returns an estimated location of the user's IP address. In some embodiments, the user's location is determined by comparing the user's IP address to a local geolocation database stored within memory 510.

In some embodiments, a tuning factor is determined by the machine learning system 540 using patterns identified by the machine learning system 540. For example, if the machine learning system 540 identifies that a current tuning factor being used by project estimator 518 is chronically underestimating or overestimating projects, the machine learning system 540 may adjust (e.g., lower, raise, etc.) the tuning factor to cause the project estimator 518 to more accurately generate estimates. In some embodiments, machine learning system 540 adjusts other parameters (e.g., component configuration data stored in component database 526) and a tuning factor to cause the building system planning tool 512 to more accurately develop a budget and/or cost estimate.

As shown, in some embodiments, information tab 702 includes product preferences 730 (e.g., product parameters, product criteria, etc.). As shown in FIG. 7, product preferences 730 include default controller series preferences 732 (e.g., generation 1, generation 3, generation 4, etc.), variable frequency drives preferences 734 (e.g., 3^{rd} party, with bypass, without bypass, etc.), air handling unit dampers preferences 736 (e.g., 3^{rd} party, galvanized airfoil Class 1A rated, etc.), and air flow monitoring station preferences 738 (e.g., differential pressure, thermal dispersion, etc.). In some embodiments, user interface 700 includes hide/show buttons 739, which may hide or show information within containers. For example, a user may select hide/show button 739 associated with project settings 710 to hide the information contained within the project settings 710 container (e.g., vertical market information 712, project complexity information 714, etc.).

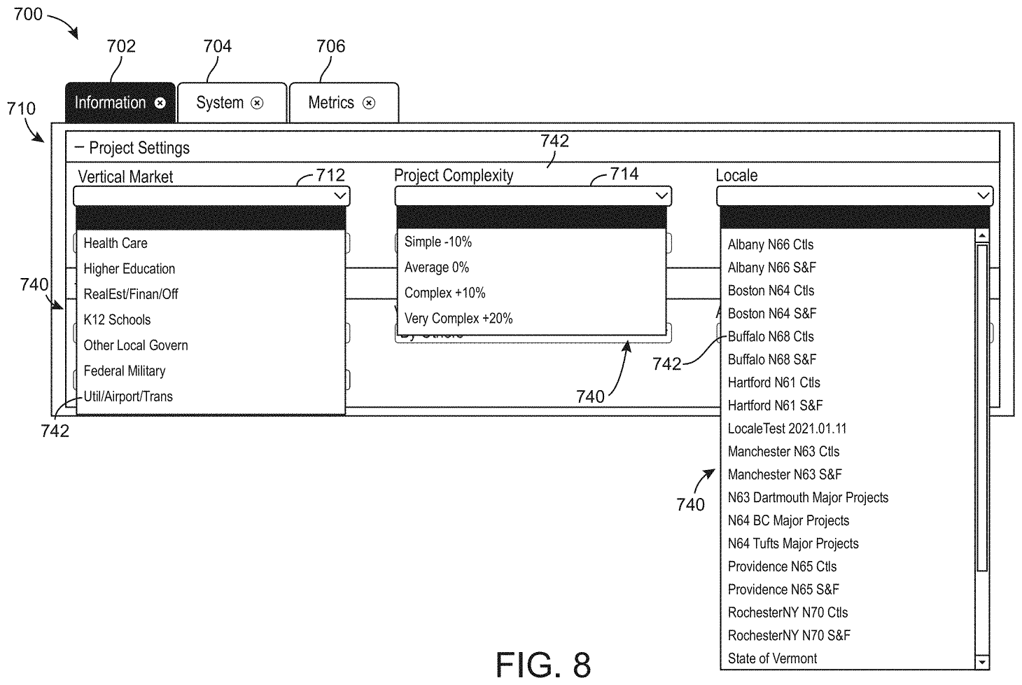

Referring now to FIG. 8, drop down menus 740 for project settings 710 are shown with example user selectable options displayed, according to some embodiments. In some embodiments, a user may select a user selectable option 742 from the drop down menus 740 to populate the associated fields.

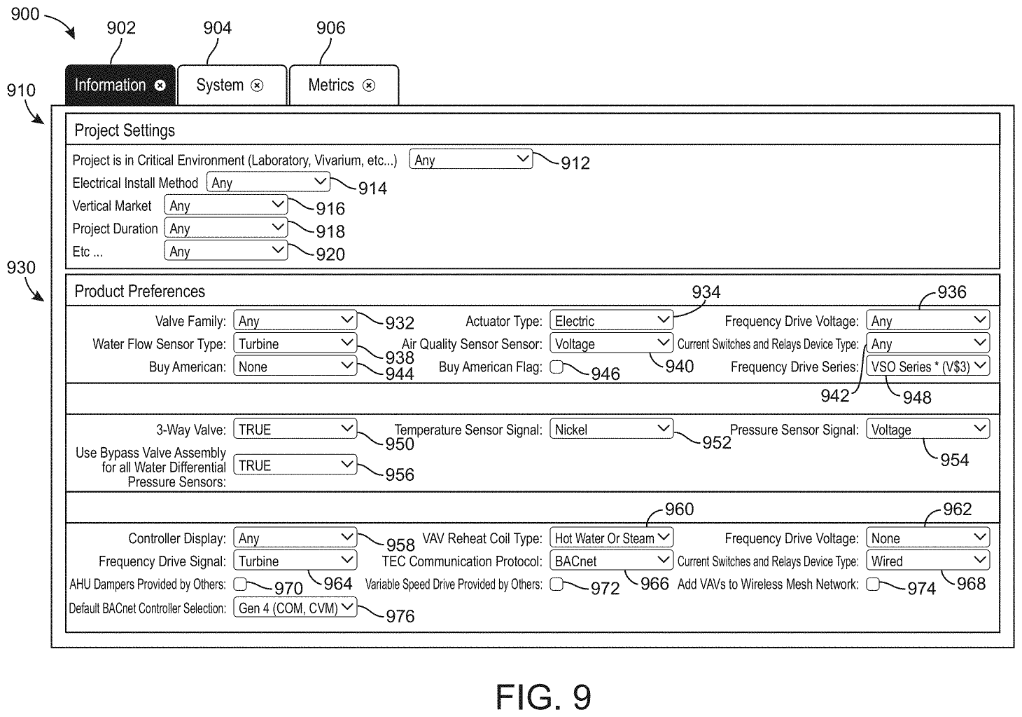

Referring now to FIG. 9, a user interface 900 is shown, according to some embodiments. User interface 900 may be similar to or different than user interface 700. User interface 900 may include more or fewer selectable options than user interface 700. User interface 900 may have some or all of the features of user interface 700. Likewise, user interface 700 may have some or all of the features of user interface 900. As shown, user interface 900 includes an information tab 902, system tab 704, and metrics tab 706. Information tab 902 is shown to include project settings 910 including critical environment information 912 (e.g., laboratory, vivarium, museum, etc.), electrical installation method information 914, vertical market information 916, project duration information 918, and other project settings 920. User interface 900 further includes product preferences 930 including valve family preferences 932, actuator type preferences 934, frequency drive voltage preferences 936, water flow sensor type preferences 938, air quality sensor signal preferences 940, current switches and relay device type preferences 942, buy American preferences 944 (e.g., a preference for or against American made products), buy American flag preferences 946, frequency drive series preferences 948, 3-way valve preference 950, temperature sensor signal preference 952, pressure sensor signal 954, use bypass valve assembly for all water differential pressure sensors preference 956, controller display preference 958, variable air volume (VAV) reheat coil type preference 960, VAV box fan preference 962, frequency drive signal preference 964, thermoelectric cooler (TEC) communication protocol preferences 966, TEC communication preferences 968, AHU dampers provided by others preference 970, variable speed drive provided by others preference 972, add VAVs to wireless mesh network preferences 974, and default BACnet Controller selection 976. In some embodiments, product preferences 930 include more or fewer product preferences than shown in FIG. 9.

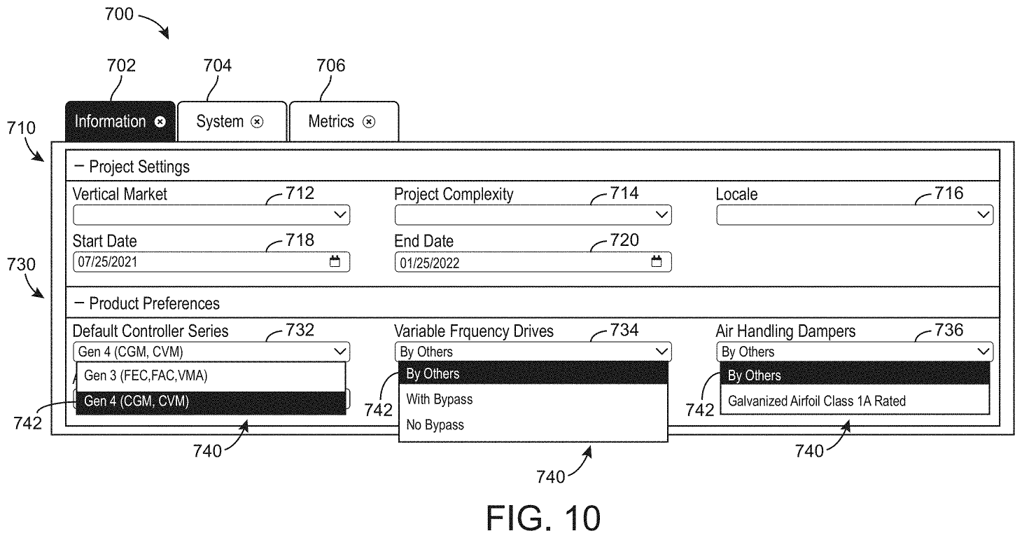

Referring now to FIG. 10, example dropdown menus 740 for product preferences 730 are shown with example user selectable options 742, according to some embodiments. As shown in FIG. 10, vertical market information 712, project complexity information 714, and locale information 716 are highlighted, according to some embodiments. In some embodiments, vertical market information 712, project complexity information 714, and locale information 716, are required before a user may advance to the system tab 704 and/or the metrics tab 706.

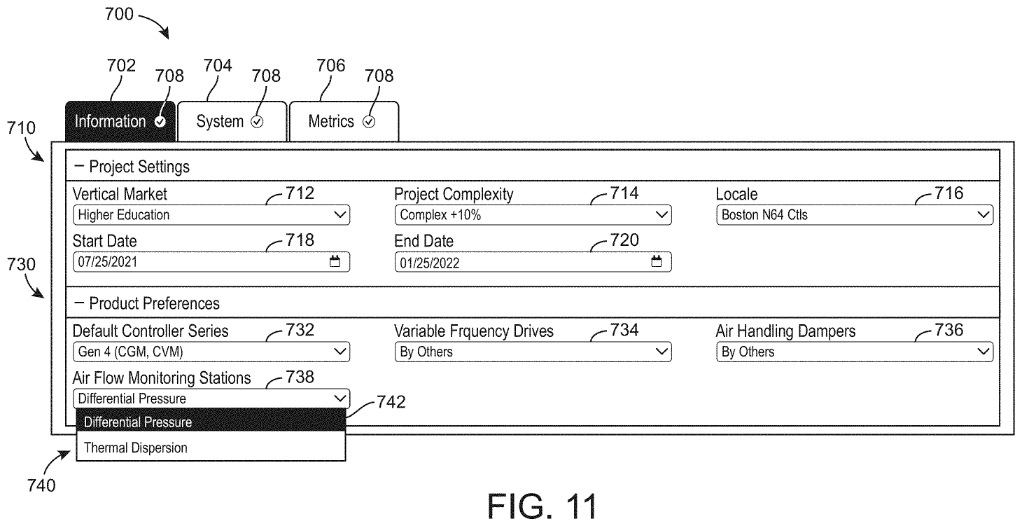

Referring now to FIG. 11, project settings 710 have been populated with information (e.g., vertical market information 712 is set to “higher education”). As shown, status identifiers 708 indicate (e.g., by a green check icon) that the required information on information tab 702 has been entered. In some embodiments, building system configuration tool 500 may retrieve information from the component database 526 and from a historical project database 528 before updating status identifiers 708. In some embodiments, building system configuration tool 500 gathers information from component database 526 and historical project database 528 after updating status identifiers 708. Status identifiers 708 may indicate that a user may navigate to the corresponding tab. In some embodiments, a user may not select the system tab 704 or the metrics tab 706 before project settings 710 have been populated. In some embodiments, a user may enter one or more large-scale factors on information tab 702, select components on system tab 704, and then enter additional large-scale factors on information tab 702 to further adjust the calculated budget and component data.

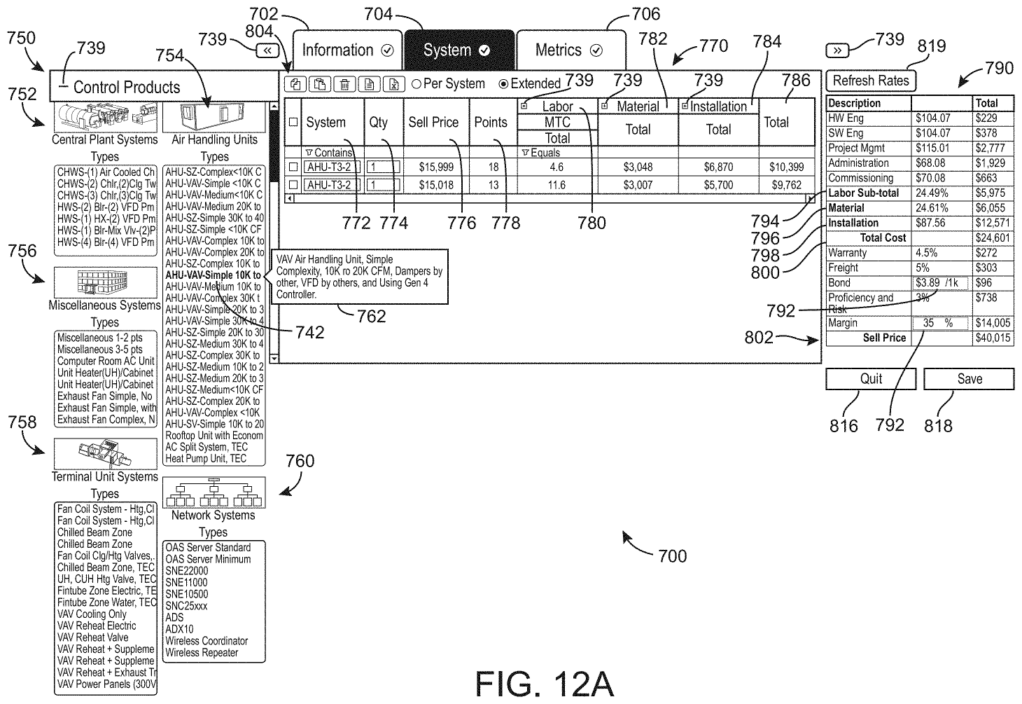

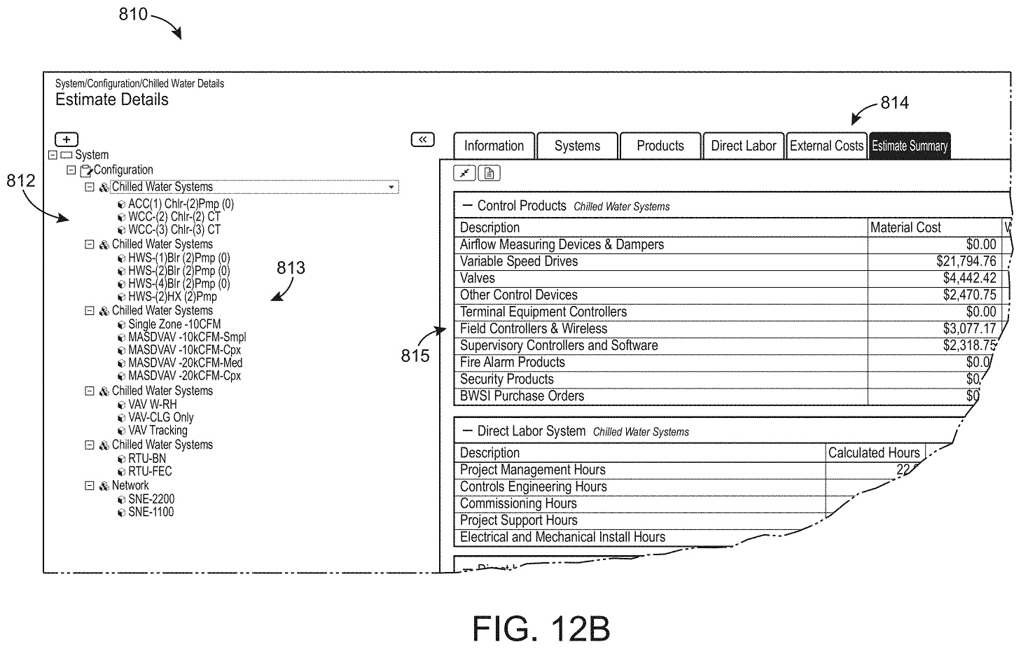

Referring now to FIG. 12A, system tab 704 is shown with a control products container 750, a selected component table 770, and a output table 790. Control products container 750 is shown to include control plant systems group 752, air handling units group 754, miscellaneous systems group 756, thermal unit systems group 758, and network systems group 760. Each group 752, 754, 756, 758, and 760 are shown to include a determined or generated list of control products that satisfy the settings and preferences entered on the information tab 702 (e.g., product preferences 730, project settings 710, etc.). In some embodiments, a user may hover over a user selectable option 742 to view a call out 762 detailing additional information for each user selectable option 742 in group 752, 754, 756, 758, and 760. In some embodiments, a user can “drag and drop” components from group 752, 754, 756, 758, and 760 into selected component table 770. In some embodiments, control products container 750 is searchable by a search bar, and subject to one or more filters.

In some embodiments, system configuration manager 516 generates a list of components from the component database 526 for control products container 750. In some embodiments, system configuration manager 516 generates a dynamic combination of components based on inputs from machine learning system 540. For example, machine learning system 540 may insert new components (e.g., artificial components) that may be desirable to a user based on trends and patterns identified by machine learning system 540. In some embodiments, machine learning system 540 is configured to also determine or estimate an associated cost of the artificial component. In this way, machine learning system 540 may develop new products that may be suitable for production and installation in building equipment systems. In some embodiments, machine learning system 540 does not insert artificial components into the component database 526. In some embodiments, system configuration manager 516 retrieves static component data from the component database 526.

As shown in FIG. 12A, a user may select a number of components from the control product container 750 to populate selected component table 770. In some embodiments, selected component table 770 includes one or more columns for the component name, shown as system column 772 (e.g., component name column), component quantity, shown as component quantity column 774, sell price, shown as sell price 776, complexity quantifier, shown as points column 778, labor cost, shown as labor column 780, material cost, shown as material column 782, installation cost, shown as installation column 784, and component total cost, shown as total column 786. In some embodiments, a user may interact with various cells of the selected component table 770 to modify component specific values (e.g., installation costs, material costs, component quantities, etc.). In some embodiments, the modified component specific values are communicated to the component database 526 and/or the machine learning system 540. In some embodiments, the components in control product container 750 are updated with local labor rates, local tax rates, and other locale specific information. Additionally, the components in control product container 750 may be updated with project setting specific price adjustments (e.g., tuning factors, multipliers, markup, margins, etc.) for the vertical market information 712, project complexity information 714, locale information 716, start date 718, and end date 720.

In some embodiments, output table 790 (e.g., summary table, cost summary table, etc.) is updated periodically or concurrently with changes made to selected component table 770. In some embodiments, output table 790 summarizes data (e.g., components, component costs, etc.) from the selected component table 770. As shown, output table 790 displays labor breakdowns including hardware engineering costs, software engineering costs, project management costs, administration costs, commissioning costs, warranty cost, freight cost, bond cost, proficiency and risk cost, and margin. In some embodiments, output table 790 includes user adjustable fields 792. As shown, output table 790 includes a labor sub-total cost 794, a material total cost 796, an installation total cost 798, a total cost 800. Total cost 800 is a sum of labor sub-total cost 794, material total cost 796, and installation total cost 798, according to some embodiments. As shown, output table 790 further includes a sell price 802. A person having ordinary skill in the art will appreciate the relationships between differently line items in output table 790 are summations of subcategories. For example, administration costs may be a summation of all administration costs for each component in the selected component table 770, and total cost may be a summation of labor costs, material costs, and installation costs for each component.

In some embodiments, a user may toggle between information tab 702 and system tab 704 to modify or add project settings 710, and product preferences 730, and selected components in selected components table 770. In some embodiments, a user may be required to enter information (e.g., component selections) on system page 704 before entering information (e.g., project settings 710, product preferences 730, etc.) on information tab 702. In some embodiments, a user may enter information on both information tab 702 and system tab 704 to generate an initial estimate and component list, and then further adjust the estimate and component list by adjusting information on the information tab 702 and system tab 704 to generate a second estimate and second component list. In some embodiments, a user may interact with the metrics tab 706 before generating a second estimate and component list. In some embodiments, the user is influenced by information (e.g., historical project information) on metrics tab 706 to modify information on information tab 702 and system tab 704. In some embodiments, project comparer 520 and/or system configuration manager 516 is configured to automatically adjust information on information tab 702 and system tab 704 to adjust the initial budget and component list and aid the user in developing the second budget and second component list. In some embodiments, project comparer 520 is configured to adjust information on the information tab 702 and system tab 704 to generate a second budget (i.e. adjust the initial budget), to be more similar to a representative project based on the filtered set of historical project data.

Referring now to FIG. 12B, after a user has selected all desired or necessary components listed in control product container 750 and populated and/or updated selected component table 770, the user may export the selected component table 770 information to an external file or other report format using export buttons 804, according to some embodiments. Export buttons 804 may export the data in selected component table 770 to a desired file format or report. For example, a user may interact with export buttons 804 to generate estimate detail report 810. In some embodiments, estimate detail report 810 includes component menu 812 and estimate detail tabs 814. In some embodiments, component menu 812 includes component tree 813 which details components and subcomponents included in the estimate detail report 810. In some embodiments, estimate detail tabs 814 include detail tables 815. Detail tables 815 may display additional cost breakdowns for each component included in the estimate detail report 810. In some embodiments, estimate detail report 810 may detail the selected components used in output table 790, according to some embodiments. In some embodiments, estimate detail report 810 may be displayed on a tab (e.g., a tab after metrics tab 706). In some embodiments, estimate detail report 810 includes a proposal breakout form which can be used as a sales tool for explaining project metrics to a perspective purchaser (e.g., a customer, a client, a buyer, etc.) of the building equipment system. In some embodiments, the proposal breakout form may be included on a tab (e.g., a tab before or after metrics tab 706). In some embodiments, the proposal breakout form may improve (e.g., widen) margins by demonstrating the complexities and considerations (e.g., large scale factors) of the building equipment system.

In some embodiments, export buttons 804 may export data to a report having a format suitable for engineering, such as a bill of materials or a computer aided engineering file. In some embodiments, the bill of materials includes the selected components and intermediate components necessary for the combinations of components selected (e.g., wiring requirements, piping requirements, ductwork requirements, operating weight and structural support requirements, mechanical couplers requirements, electrical couplers requirements, etc.). In some embodiments, the export buttons 804 are configured to output an equipment layout, or prepopulate an engineering file with the selected components to allow for more rapid development of the building system.

In some embodiments, user interface 700 includes an end session button, shown as quit button 816. In some embodiments, user interface 700 includes a save session button, shown as save button 818. In some embodiments, quit button 816 allows a user to exit the user interface 700. In some embodiments, save button 818 may allow a user to save the selected control products and other user input information. In some embodiments, save button 818 may communicate the current budget information to the historical project database 528. In some embodiments, a user may select a refresh rate button 819 to refresh the local labor rates.

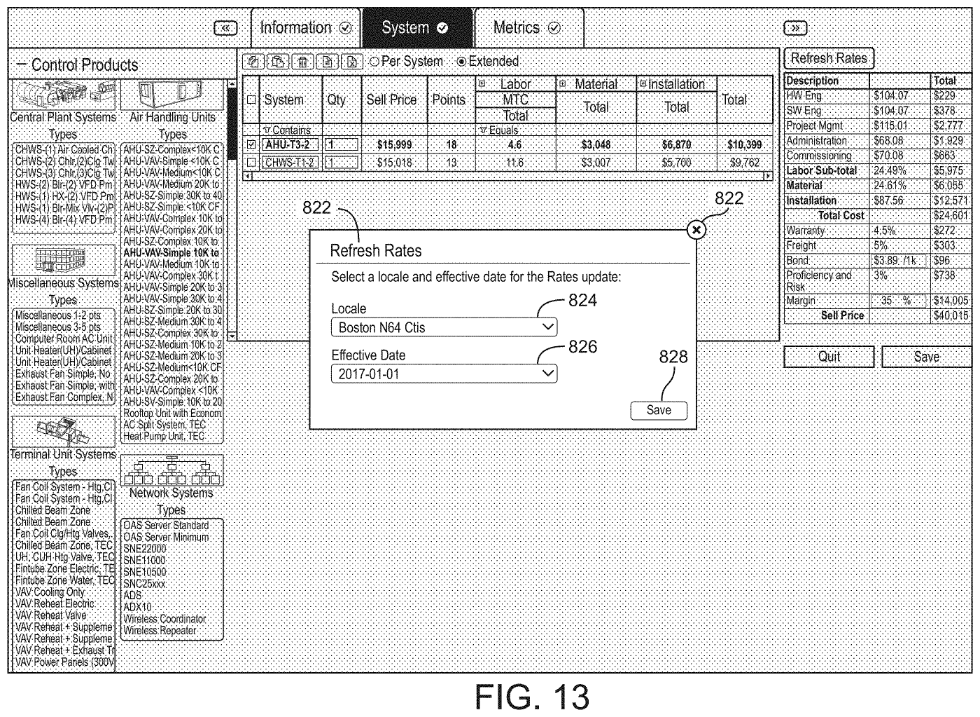

Referring now to FIG. 13, a user has interacted with refresh rate button 819 and popup window 822 provides a field for a user to input local update information 824 and effective date information 826. A user may update locale information 716 though popup window 822. In some embodiments, a user may update locale information 716 to view labor rates in similar other locales. A user may exit the popup window 822 by selecting close window button 820, or save the updated information using save button 828.

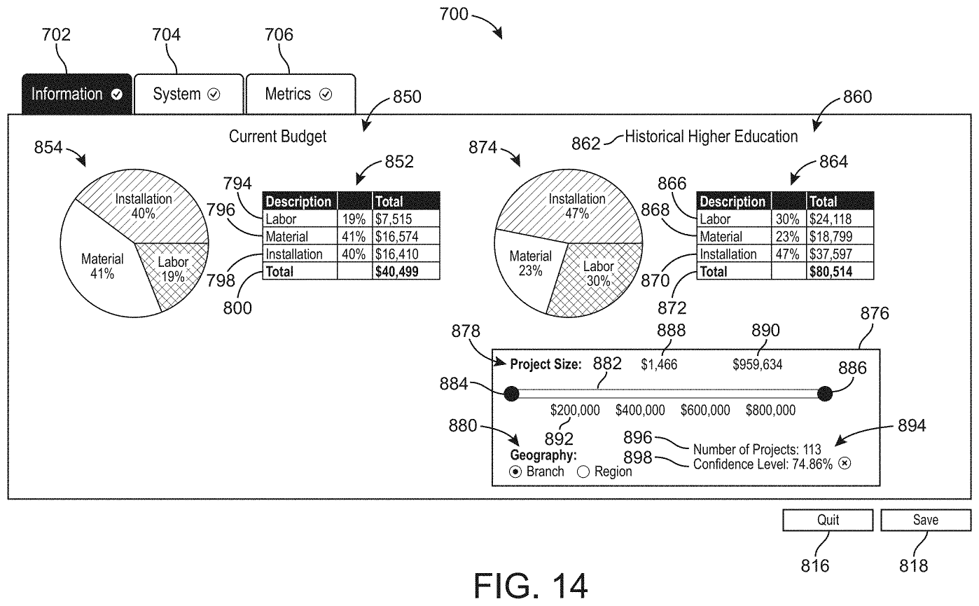

Referring now to FIG. 14, metrics tab 706 is shown with a current project portion 850, and a historical project portion 860, according to some embodiments. As shown, current project portion 850 includes project metrics, shown as calculated budget table 852. Calculated budget table 852 may include rows for labor costs 794, material costs 796, installation costs 798, and total cost 800. In some embodiments, the labor costs 794, material costs 796, and installation costs 798 are displayed as a percentage of total cost 800 in visual numerical proportion graphic 854 (e.g., a pie chart). As shown, calculated budget table 852 summarizes the labor costs 794, material costs 796, installation costs 798, and total cost 800 as displayed in the output table 790 shown in FIG. 12A. In some embodiments, calculated budget table 852 is the same as output table 790. In some embodiments, calculated budget table 852 is calculated by project estimator 518 based on user supplied project settings 710 and selected components stored in selected component table 770.

As shown in FIG. 14, historical project portion 860 includes a first project setting identifier, shown as vertical market indicator 862. Vertical market indicator 862 may indicate a first filter applied to the project data stored in historical project database 528 based on the vertical market information 712 input by the user. As shown, historical project portion 860 includes a representative cost table 864 displaying a representative labor cost 866, a representative material cost 868, a representative installation cost 870, and a representative total cost 872. The representative labor cost 866, representative material cost 868, and representative installation cost 870 are displayed as a percentage of representative total cost 872 in representative visual numerical proportion graphic 874. In some embodiments, project comparer 520 determines the representative cost table 864 based on filtered historical project data stored in historical project database 528. As shown, historical project portion 860 includes a user configurable representative project criteria portion, shown as representative criteria portion 876. In some embodiments, representative criteria portion 876 includes project size criteria 878 and geographical criteria 880.

In some embodiments, project size criteria 878 includes setting a project price range to filter the historical budget data stored in historical project database 528. As shown, project size criteria 878 includes a project size slider bar 882 with a lower slider 884 and an upper slider 886. In some embodiments, the project size criteria 878 is entered using fields for entering a lower limit and an upper limit. As shown, lower slider 884 corresponds to lower range value 888 and upper slider 886 corresponds to upper range value 890. In some embodiments, lower range value 888 and upper range value 890 are dollar amounts, and slider bar tick marks 892 are tick marks of the same unit. In some embodiments, lower range value 888 and upper range value 890 are not dollar amounts and may be other metrics such as square footage, labor hours, etc. In some embodiments, geographical criteria 880 may allow a user to select a location, region, branch, or proximity, to filter the historical budget data stored in historical project database 528. As shown, geographical criteria 880 includes a branch option and a region option which are selectable by a user though radio buttons. In an exemplary embodiment, historical budget data stored in historical project database 528 is filtered on vertical market information 712, the project size range specified by lower slider 884 and upper slider 886, and geographical criteria information 880 before determining the representative labor cost 866, representative material cost 868, representative installation cost 870, and representative total cost 872, and associated statistical measure portion 894.

In some embodiments, representative criteria portion 876 may include a statistical measure portion 894 which may output relevant statistical measures for describing the representative budget in context of the filtered historical budget data. As shown, statistical measure portion 894 includes a first statistical measure, shown as sample size 896, and a second statistical measure, shown as confidence level 898 (described in greater detail below). A person of ordinary skill in the art will appreciate that additional or different statistical measures (e.g., mean, median, mode, percentiles, range, variance, standard deviation, etc.) may be presented to describe the representative budget in context of the filtered historical dataset.

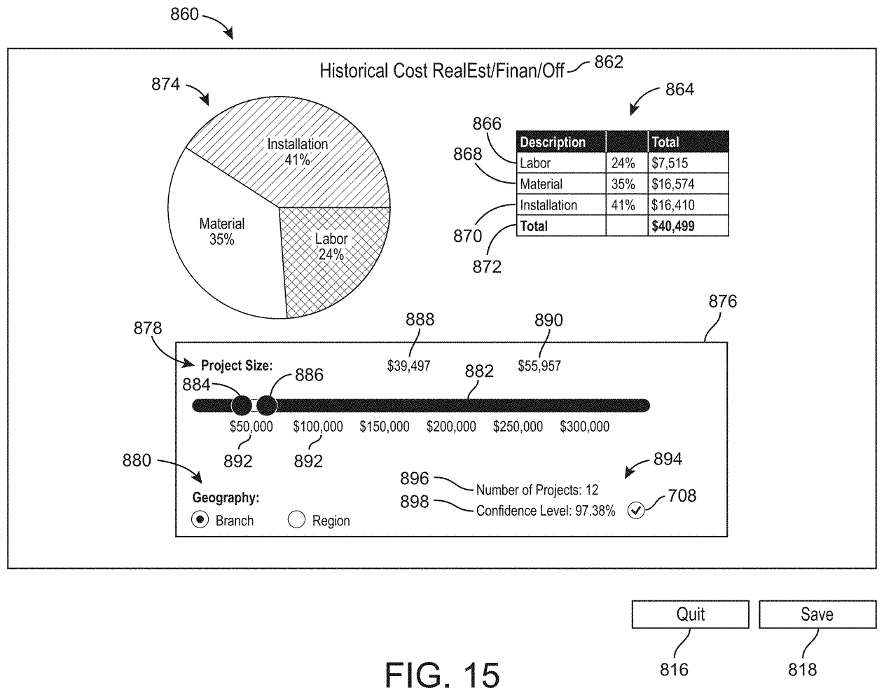

Referring now to FIG. 15, lower slider 884 and upper slider 886 are located at $39,497 and $55,957, respectively, according to some embodiments. As shown, vertical market indicator 862 indicates that the vertical market is real-estate or financial offices. As shown, sample size 896 is 12 projects, and the confidence level is 97.38%. In some embodiments, the confidence level indicates the probability that the representative budget falls within the set of data stored in the historical project database 528 that satisfies filter criteria (e.g., vertical market, project complexity, locale information, project size, etc.). For example, the confidence level 989 may be calculated using the equation:

$$CI = \overline{x} \pm z ( \frac{s}{\sqrt{n}} )$$

where CI is the confidence interval, x̅ is the sample mean, z is the confidence level value, s is the sample standard deviation, and n is the sample size. In some embodiments, n represents the number of samples in the filtered data, which is shown as sample size 896. In some embodiments, the sample mean is the average cost of the filtered data, shown as total cost 872. In some embodiments, the standard deviation, s, is the standard deviation of the filtered data. In some embodiments, confidence level 898 is determined by solving the above equation for z.

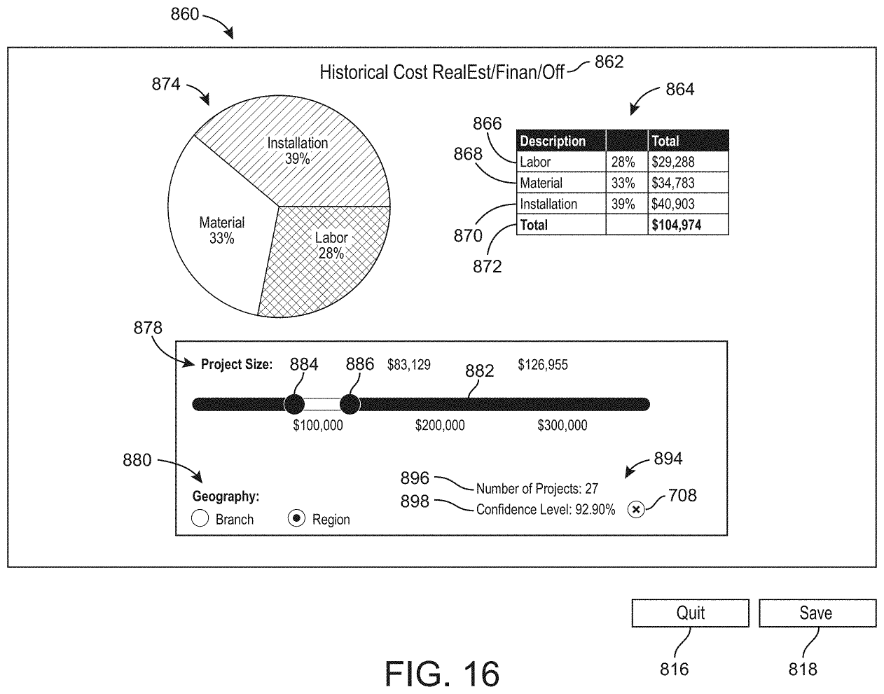

In some embodiments, the confidence level 898 includes a status identifier 708 for indicating whether the confidence level 898 is above a desired threshold (e.g., 95% confidence level, 97% confidence level, etc.). By contrast, as shown in FIG. 16, the lower slider 884 is at $83,129 and the upper slider 886 is at $126,955. The sample size 896 is 27 and the confidence level 898 is 92.90% which is indicated as being below the desired threshold by status identifier 708. In some embodiments, the historical project portion 860 is an average of the historical projects in the filtered range. In some embodiments, more than one historical project portion is generated to compare between different filter criteria (e.g., project size, geographical region, vertical market, labor rate, etc.) for the historical budget dataset.

Referring again to FIG. 14, as upper slider 886 and lower slider 884 approach the ends of the project size slider bar 882, the confidence level 898 may be lower than a more narrow range between upper slider 886 and lower slider 884 (see, e.g., FIG. 15). In some embodiments, this may be due to a skew in the filtered historical project data wherein ranges including large projects (e.g., expensive projects) tend to have a negative skew (e.g., due to rounding up, more expensive components, more flexible budgets, etc.) and smaller sized project ranges tend to have a positive skew (e.g., rounding down to meet strict budgets). In some embodiments, the variance of the filtered historical project data is larger for larger product ranges.

In some embodiments, confidence level 898 allows a user of the building system configuration tool 500 to determine the statistical relevance of the representative project cost information displayed in representative cost table 864. For example, when a user of the building system configuration tool 500 filters the historical project data stored in the historical project database 528 using user selected criteria (e.g., project size criteria 878, geographical criteria 880, etc.) yielding a small (e.g., small population/sample size), inaccurate (e.g., misleading historical project information), random (e.g., randomly distributed historical project information), or otherwise statistically undesirable statistical determination, the confidence level 898 may indicate a low confidence and the user may decide to adjust the filter criteria or may decide to disregard the representative project cost. In some embodiments, the project comparer 520 is configured to automatically adjust the filter criteria (e.g., upper slider 886 and lower slider 884) to cause the representative total cost 872 to be approximately the same as total cost 800. For example, project comparer 520 may treat upper slider 886 and lower slider 884 as input variables and set a condition of representative total cost 872 equal to total cost 800 as a goal. In such example, project comparer 520 may implement an iterative method to step though possible combinations of upper slider 844 and lower slider 866 to determine combinations of lower slider 884 and upper slider 886 which achieve the goal. In some embodiments, project comparer 520 uses a method other than an iterative method to solve for combinations of upper slider 844 and lower slider 866 to achieve the goal. In some embodiments, project comparer 520 may determine a plurality of possible solutions and select the most statistically relevant solution (e.g., the solution with the highest confidence level) based on statistical measure portion 894. In some embodiments, a user manually positions lower slider 884 and upper slider 886 to achieve the goal. In some embodiments, project comparer 520 is configured to automatically adjust one or more profit margins, markups, tuning factors, multipliers, components, or component selections to cause the current project to be similar to the representative budget.

In some embodiments, generating a representative budget similar to the current project budget allows a user to determine if the calculated budget table 852 has similar costs as historical budgets stored in the historical project database 528. By comparing the current project portion 850 to the historical project portion 860, a user may determine if budget is consistent with historical budget information having similar criteria. In some embodiments, comparing current project portion 850 to the historical project portion 860 increases the consistency and accuracy of estimated budgets irrespective of an individual's experience with quoting building equipment systems.

In various embodiments, the systems and methods described herein can be used to estimate the capital costs of purchasing and installing building equipment in new buildings and/or upgrading or replacing existing building equipment in existing buildings (e.g., upgrading or replacing existing building infrastructure with newer more efficient equipment). In some embodiments, the systems and methods described herein can be used in combination with the system described in U.S. patent application Ser. No. 17/193,233 titled “Operations and Maintenance Development Tool” and filed Mar. 5, 2021, the entire disclosure of which is incorporated by reference herein. For example, the cost estimates generated using the systems and methods described herein can be provided as an input to the system described in U.S. patent application Ser. No. 17/193,233 and compared against the expected efficiencies that can be gained (e.g., reduced operational costs and/or maintenance costs) by making such capital investments to determine whether the capital costs are offset over a given time period.

### CONFIGURATION OF EXEMPLARY EMBODIMENTS

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A user-interactive tool for configuring a building equipment system, the user-interactive tool comprising:
one or more processors; and
one or more memory devices having instructions stored thereon that, when executed by the one or more processors, cause the one or more processors to perform operations comprising:
receiving a first user input comprising project information including an attribute of a prospective building equipment installation project;
obtaining equipment configuration data for a plurality of building equipment components capable of being included in the building equipment system based on the project information;
receiving a second user input comprising a selected subset of the plurality of building equipment components, the selected subset defining a configuration of the building equipment system;
generating a predicted metric of the building equipment system based on the project information and the configuration of the building equipment system;
generating a representative metric of a set of historical building equipment installation projects that satisfy the attribute of the prospective building equipment installation project;
displaying, via a graphical user interface, the predicted metric of the building equipment system and the representative metric of the set of historical building equipment installation projects; and
adjusting the configuration of the building equipment system based on the representative metric.

2. The user-interactive tool of claim 1, the operations comprising communicating the project information to a machine learning system configured to use the project information and one or more patterns identified in the set of historical building equipment installation projects to determine at least one of the plurality of building equipment components capable of being used in the building equipment system.

3. The user-interactive tool of claim 1, wherein the project information comprises at least one of vertical market information, project complexity information, locale information, start date information, and end date information.

4. The user-interactive tool of claim 1, the operations further comprising receiving a third user input comprising equipment preferences including at least one of a controller preference, a variable frequency drive preference, an air handling unit preference, a damper preference, or an air flow monitoring station preference; and
wherein the equipment configuration data are obtained based on both the project information and the equipment preferences.

5. The user-interactive tool of claim 1, wherein adjusting the configuration of the building equipment system comprises automatically changing the selected subset of the plurality of building equipment components to decrease a difference between the predicted metric and the representative metric.

6. The user-interactive tool of claim 1, the operations further comprising filtering the set of historical building equipment installation projects to generate a filtered subset based on user-configurable project criteria comprising at least one of a project cost criterion and a geographical criterion; and
wherein the representative metric is generated based on the filtered subset.

7. The user-interactive tool of claim 1, the operations comprising:
generating an initial value of the predicted metric based on the configuration of the building equipment system and without using the project information; and
adjusting the initial value of the predicted metric based on the project information to generate an adjusted value of the predicted metric.

8. The user-interactive tool of claim 1, the operations further comprising:
determining a statistical measure of the representative metric based on historical cost data associated with the set of historical building equipment installation projects; and
displaying the statistical measure via the graphical user interface.

9. The user-interactive tool of claim 1, wherein at least one of the predicted metric or the representative metric comprises a plurality of sub-metrics including a labor metric, a materials metric, and an installation metric.

10. The user-interactive tool of claim 1, the operations comprising:
identifying one or more required building equipment components missing from the selected subset; and
adjusting the configuration of the building equipment system by adding the one or more required building equipment components to the selected subset.

11. A method for configuring a building equipment system, the method comprising:
receiving a first user input comprising project information including an attribute of a prospective building equipment installation project;
obtaining equipment configuration data for a plurality of building equipment components capable of being included in the building equipment system based on the project information;
receiving a second user input comprising a selected subset of the plurality of building equipment components, the selected subset defining a configuration of the building equipment system;
generating a predicted metric of the building equipment system based on the project information and the configuration of the building equipment system;
generating a representative metric of a set of historical building equipment installation projects that satisfy the attribute of the prospective building equipment installation project;
displaying, via a graphical user interface, the predicted metric of the building equipment system and the representative metric of the set of historical building equipment installation projects; and
adjusting the configuration of the building equipment system based on the representative metric.

12. The method of claim 11, comprising communicating the project information to a machine learning system configured to use the project information and one or more patterns identified in the set of historical building equipment installation projects to determine at least one of the plurality of building equipment components capable of being used in the building equipment system.

13. The method of claim 11, wherein the project information includes at least one of a vertical market information, a project complexity information, a locale information, a start date information, and an end date information.

14. The method of claim 11, the method further comprising receiving a third user input comprising equipment preferences including at least one of a controller preference, a variable frequency drive preference, an air handling unit preference, a damper preference, or an air flow monitoring station preference; and
wherein the equipment configuration data are obtained based on both the project information and the equipment preferences.

15. The method of claim 11, further comprising filtering the set of historical building equipment installation projects to generate a filtered subset based on user-configurable project criteria comprising at least one of a project cost criterion and a geographical criterion; and
wherein the representative metric is generated based on the filtered subset.

16. The method of claim 11, wherein adjusting the configuration of the building equipment system comprises automatically changing the selected subset of the plurality of building equipment components to decrease a difference between the predicted metric and the representative metric.

17. The method of claim 11, wherein the method further comprises determining a statistical measure of the representative metric based on historical cost data associated with the set of historical building equipment installation projects; and
displaying the statistical measure via the graphical user interface.

18. One or more non-transitory computer-readable storage media comprising instructions thereon that when executed by one or more processors, cause the one or more processors to:
receive a first user input comprising project information including an attribute of a prospective building equipment installation project;
obtain equipment configuration data for a plurality of building equipment components capable of being included in a building equipment system based on the project information;
receive a second user input comprising a selected subset of the plurality of building equipment components, the selected subset defining a configuration of the building equipment system;
generate a predicted metric of the building equipment system based on the project information and the configuration of the building equipment system;
generate a representative metric of a set of historical building equipment installation projects that satisfy the attribute of the prospective building equipment installation project;
display, via a graphical user interface, the predicted metric of the building equipment system and the representative metric of the set of historical building equipment installation projects; and
adjust the configuration of the building equipment system based on the representative metric.

19. The one or more non-transitory computer-readable storage media of claim 18, wherein the instructions further cause the one or more processors to communicate the project information to a machine learning system configured to use the project information and one or more patterns identified in the set of historical building equipment installation projects to determine at least one of the plurality of building equipment components capable of being used in the building equipment system.

20. The one or more non-transitory computer-readable storage media of claim 18, wherein the instructions further cause the one or more processors to filter the set of historical building equipment installation projects to generate a filtered subset based on user-configurable project criteria comprising at least one of a project cost criterion and a geographical criterion; and
wherein the representative metric is generated based on the filtered subset.
